(19) United States
(12) Patent Application Publication
(10) Pub. No.: US 2024/0015623 A1
(43) Pub. Date: Jan. 11, 2024

(54) BEAM MANAGEMENT IN NON-TERRESTRIAL NETWORKS

(71) Applicant: MEDIATEK INC., Hsinchu (TW)

(72) Inventors: Chun-Chia CHEN, Hsinchu (TW); Bao-Chi PENG, Hsinchu (TW); Chen-I LIAO, Hsinchu (TW); Shao-Chou HUNG, Hsinchu (TW); I-Kang FU, Hsinchu (TW)

(73) Assignee: MEDIATEK INC., Hsinchu (TW)

(21) Appl. No.: 18/329,779

(22) Filed: Jun. 6, 2023

Related U.S. Application Data
(60) Provisional application No. 63/367,733, filed on Jul. 6, 2022.
(60) Provisional application No. 63/367,734, filed on Jul. 6, 2022.
(60) Provisional application No. 63/367,735, filed on Jul. 6, 2022.
(60) Provisional application No. 63/367,736, filed on Jul. 6, 2022.
(60) Provisional application No. 63/367,737, filed on Jul. 6, 2022.

(51) Int. Cl. H04W 36/08; H04W 36/30; H04W 48/20

(52) U.S. Cl. CPC H04W 36/083; H04W 36/30; H04W 48/20

(57) ABSTRACT

A method can include determining an initial beam configuration by a controller at a satellite in a non-terrestrial network (NTN); applying the initial beam configuration to control an antenna array to transmit a beam to cover a target service area; determining subsequent beam configurations, by the controller, corresponding to a sequence of locations along an orbit of the satellite; and applying the subsequent beam configurations at each of the sequence of locations successively to control the antenna array to transmit respective beams to cover the target service area while the satellite is flying along the orbit. The controller determines the initial beam configuration and the subsequent beam configurations in a way that a variation of beam footprints of the beams is minimized to realize a constant beam footprint corresponding to the target service area.

### INCORPORATION BY REFERENCE

This present application claims the benefit of U.S. Provisional Application No. 63/367,733, filed on Jul. 6, 2022, No. U.S. 63/367,734, filed on Jul. 6, 2022, No. U.S. 63/367,735, filed on Jul. 6, 2022, No. U.S. 63/367,736, filed on Jul. 6, 2022, and No. U.S. 63/367,737, filed on Jul. 6, 2022, which are incorporated herein by reference in their entirety.

### TECHNICAL FIELD

The present disclosure relates to wireless communications and, more specifically, to beam management in non-terrestrial networks.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Non-terrestrial networks (NTN) can include satellite communication networks, high altitude platform systems (HAPS), air-to-ground networks, unmanned aerial vehicles (UAV), and the like. Satellite communication networks can be based on low Earth orbiting (LEO) satellites, medium Earth orbiting (MEO) satellites, and geostationary Earth orbiting (GEO) satellites. The 3rd Generation Project Partnership (3GPP) is developing new standards to adapt 5G New Radio (NR) to NTNs.

### SUMMARY

Aspects of the disclosure provide a method. The method can include determining an initial beam configuration by a controller at a satellite in a non-terrestrial network (NTN); applying the initial beam configuration to control an antenna array to transmit a beam to cover a target service area; determining subsequent beam configurations, by the controller, corresponding to a sequence of locations along an orbit of the satellite; and applying the subsequent beam configurations at each of the sequence of locations successively to control the antenna array to transmit respective beams to cover the target service area while the satellite is flying along the orbit. The controller determines the initial beam configuration and the subsequent beam configurations in a way that a variation of beam footprints of the beams is minimized to realize a constant beam footprint corresponding to the target service area.

In an example, the determination of the initial beam configuration and the subsequent beam configuration is based on a beambook including a list of beam configurations each corresponding to a beam configuration reference. In an example, the beam configuration reference is one of a time point, a satellite location, a range of time, a range of satellite locations, a beam steering angle of a beam transmitted from a satellite, a range of beam steering angles of beams transmitted from a satellite.

In an example, each beam configuration on the list of beam configurations is represented by a beam configuration index that is associated with a beam configuration in a set of beam configurations. In an example, each beam configuration on the list of beam configurations includes a set of parameters each corresponding to an antenna element of the antenna array, each parameter including one of an on/off indication corresponding to the respective antenna element, an amplitude and a phase corresponding to the respective antenna element, and an amplitude and a delay corresponding to the respective antenna element.

In an example, the beambook is derived by the controller based on a set of beam configurations received from a gateway station, a ground station, or a telemetry, tracking and command (TT&C) system. In an example, the beambook is received from a gateway station, a ground station, or a TT&C system. In an example, the determination of the initial beam configuration and the subsequent beam configuration includes determining a beam steering angle based on a location and a size of the target service area, a satellite ephemeris, and a current location of the satellite; and based on the beam steering angle, determining the respective beam configuration based on the beambook that includes a list of beam steering angles each associated with a beam configuration.

In an example, the target service area is one of one or more service areas served by a control beam, and a scheduled area served by a data beam. In an example, the method can further include determining whether to apply one of the subsequent beam configurations to adjust a beam footprint based on a number of user equipment (UEs) in an area affected by adjusting the beam footprint, wherein, when a number of connected-mode UE in the area is greater than a threshold, the controller determines not to adjust the beam footprint.

In an example, the method can further include determining whether to apply one of the subsequent beam configurations to adjust a beam footprint based on an interference to a neighboring cell of the target service area, wherein, when the interference to the neighboring cell is greater than a threshold, the controller determines to shrink the beam footprint size.

In an example, the method can further include determining whether to apply one of the subsequent beam configurations to adjust a beam footprint based on a signal quality measured by a UE served by a current beam of the satellite. When the signal quality is below a threshold and the UE is in an area affected by the adjusting the beam footprint, the controller initiates a handover to another beam/cell for the UE and subsequently shrinks the beam footprint, and when the signal quality is below a threshold and the UE is not in the area affected by the adjusting the beam footprint, the controller determines to shrink the beam footprint.

In an example, the method can further include determining whether to apply one of the subsequent beam configurations to adjust a beam footprint based on a preference of a UE, wherein when the UE is in an area affected by adjusting the beam footprint and prefers using a current beam of the satellite, the controller determines not to adjust the beam footprint.

In an example, the method can further include determining whether to apply one of the subsequent beam configurations to adjust a beam footprint based on how many beams being used to serve a UE in an area affected by adjusting the beam footprint, wherein when a current beam of the satellite is the only beam to serve the UE, the controller determines not to shrink the beam footprint.

In an example, the method can further include determining whether to apply one of the subsequent beam configurations to adjust a beam footprint based on a network preference, the network preference including one of a preference based on a user service subscription, a preference based on a service priority, and a type of a service.

In an example, the method can further include transmitting a command to a connected-mode UE in the target service area when a steering angle of a current beam of the satellite reaches a predefined angle, the command including a conditional handover configuration command or a handover command or a release message that includes one of a time when a service of the current beam is to stop, an inactive timer for the UE to go into a sleep state, and a set of satellite ephemeris information of one or more satellites.

In an example, the method can further include broadcasting system information to an idle-mode or inactive-mode UE in the target service area when a steering angle of a current beam of the satellite reaches a predefined angle, the system information including one of a time when a service of the current beam is to stop, an inactive timer for the UE to go into a sleep state, and a set of satellite ephemeris information of one or more satellites.

Aspects of the disclosure provide another method. The method can include measuring, by a user equipment (UE), a reference signal transmitted via a beam from a satellite to obtain measurement results; determining an elevation angle of the satellite; and transmitting assistance information to the satellite, the assistance information including the measurement results and the elevation angle.

In an example, the assistance information further includes at least one of a required service time for a service provided by the satellite, a UE preference indicating a list of cell identifiers (IDs) the UE prefers to utilize, and an indication whether the UE continues to use a current beam serving the UE.

In an example, the method can further include when a steering angle of a serving beam from the satellite reaches a predefined threshold, deprioritizing or excluding the serving beam for cell reselection, and performing cell reselection to camp on a neighbor cell of another beam transmitted by another satellite.

Aspects of the disclosure provide another method. The method can include receiving, by a user equipment (UE), cell information of cells that are each associated with a cell identifier and formed by a beam transmitted from a respective satellite; determining, by the UE, cell-selection related information based on part of the received cell information; and performing, by the UE, cell selection or reselection based on the cell information and the cell-selection related information, wherein a subset of the cells are deprioritized or excluded for the cell selection or reselection.

In an example, the cell information is received from one of a system information of serving cell, information stored in the UE, system information of a neighboring cell, and a radio resource control (RRC) release message. In an example, the cell information includes one of a reference location of one of the cells, an ephemeris of one of the respective satellites, one or more measurement quantities, a threshold of a distance between a location of the UE and a reference location of one of the cells, and a threshold of an elevation angle of one of the respective satellites with respect to the UE.

In an example, the determining cell-selection information includes determining a distance between the UE and the reference location of one of the cells. In an example, the determining cell-selection information includes determining an elevation angle of the one of the respective satellites with respect to the UE based on a UE location and the ephemeris of the one of the respective satellites. In an example, the determining cell-selection information includes determining an elevation angle of the one of the respective satellites based on a phase of each antenna element of an antenna array that corresponds to a largest reference signal received power (RSRP) measured at the UE.

In an example, the performing includes in response to a distance between a location of the UE and a reference point of one of the cells being greater than a threshold, determining to exclude or deprioritize the one of the cells for the cell selection or reselection. In an example, the performing includes in response to a variation of signal strength of one of the cells being above a threshold, determining to exclude or deprioritize the one of the cells for the cell selection or reselection.

In an example, the performing includes in response to an elevation angle of one of the respective satellites with respect to the UE is less than a threshold, determining to exclude or deprioritize one of the cells corresponding to the one of the respective satellites for the cell selection or reselection. In an example, the performing includes performing the cell selection or reselection based on priorities associated with ones of the cells that are each associated with the cell identifier and formed by the beam transmitted from the respective satellite.

In an example, the performing includes in response to one of the cells providing a service or a slice the UE prefers, prioritizing the one of the cells for the cell selection or reselection. In an example, the performing includes in response to detecting an available time of one of the cells being enough for the UE to complete a transmission, prioritizing the one of the cells for the cell selection or reselection.

In an example, the performing includes performing the cell selection or reselection based on a list of visited cells each associated with visited-cell information that includes one of available time indicating when the respective cell is available, a reference point of the respective cell, and a size of the respective cell. In an example, the performing includes performing the cell selection or reselection based on a ranking of the cells, wherein the cells are ranked based on reference points of the cells, satellite elevation angles of the cells, and detectable beams of the cells.

Aspects of the disclosure provide an apparatus comprising circuitry. The circuitry is configured to receive cell information of cells that are each associated with a cell identifier and formed by a beam transmitted from a respective satellite; determine cell-selection related information based on part of the received cell information; and perform cell selection or reselection based on the cell information and the cell-selection related information, wherein a subset of the cells are deprioritized or excluded for the cell selection or reselection.

Aspects of the disclosure provide a non-transitory computer-readable medium storing instructions that, when executed by a processor, cause the processor to perform a method. The method comprises receiving at a user equipment (UE) cell information of cells that are each associated with a cell identifier and formed by a beam transmitted from a respective satellite; determining cell-selection related information based on part of the received cell information; and performing cell selection or reselection based on the cell information and the cell-selection related information, wherein a subset of the cells are deprioritized or excluded for the cell selection or reselection.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a first scenario where the beamwidth is fixed, and the size and shape of the beam footprint change with different elevation angles.

FIG. 2 shows a second scenario where the azimuth angle of the beam changes, and the location, size, and shape of the beam footprint on the ground also change.

FIG. 3 shows an example of a non-terrestrial network (NTN) 300 according to embodiments of the disclosure.

FIG. 4 shows a beam manage process 400 for serving an earth-fixed cell according to embodiments of the disclosure.

FIGS. 5-8 illustrates a sequence of a satellite 501's operations at different time points from T1 to T10.

FIGS. 9A/9B/10A/10B/11A/11B show examples of beambooks.

FIG. 12A shows a coordinate system 1200A having x, y, and z axes.

FIG. 12B shows a three-dimensional (3D) table 1200B storing information of a beambook.

FIG. 13 shows the same coordinate system as in FIG. 12A but with additional parameters.

FIG. 14 shows a beam initialization process 1400 according to an embodiment of the disclosure.

FIG. 15 shows examples of reference points.

FIG. 16 shows a beam adaptation process 1600 according to an embodiment of the disclosure.

FIG. 17 shows a table 1700 of [X₁, X₂, . . . X_{N}; Y₁, Y₂, . . . Y_{N}] that maps a sequence of steering angles (or steering angle ranges) with a sequence of numbers of active antenna elements.

FIG. 18 shows a beamwidth adjustment process 1800 according to an embodiment of the disclosure.

FIG. 19 shows a control beam switching process 1900 according to embodiments of the disclosure.

FIG. 20 shows a cell/beam selection and reselection process 2000 according to embodiments of the disclosure.

FIG. 21 shows an apparatus 2100 according to embodiments of the disclosure.

### DETAILED DESCRIPTION OF EMBODIMENTS

I. Beam Management in Non-terrestrial Networks

Non-terrestrial networks (NTNs) are increasingly being utilized for communication to enhance the coverage of terrestrial networks (TN). An NTN can refer to a network or a segment of networks that use radio frequency resources associated with a non-terrestrial flying object. For example, NTNs can include satellite communication networks, high-altitude platform systems (HAPS s), air-to-ground networks, low-altitude unmanned aerial vehicles (UVAs), and the like. Technologies disclosed herein can be applied to any type of NTNs or a combination thereof. For example, satellites are used in many examples to explain the technologies in this disclosure. However, the disclosure is not limited to satellites. The innovative concepts disclosed herein can be applied to any space/airborne platforms, such as HAPSs, air-to-ground networks, UVAs (drones), and the like.

In some implementations, an NTN features the following system elements: (1) NTN terminal that may refer to a user equipment (UE) defined according to the Third Generation Partnership Project (3GPP) standards, or a terminal specific to a satellite system. (2) A service link that refers to the radio link between the UE and the space/airborne platform. In addition, the UE may also support a radio link with a terrestrial-based radio access network. (3) A space or an airborne platform embarking a payload that may implement either a bent-pipe or a regenerative payload configuration. A bent pipe payload can perform functions of radio frequency filtering, frequency conversion, and amplification. A regenerative payload can perform functions of radio frequency filtering, frequency conversion, and amplification as well as demodulation/decoding, switch and/or routing, coding/modulation, and the like. For example, a part of or all base station functions (e.g., gNB) can be on board the space/airborne vehicle. (4) Inter satellite/aerial links in case of regenerative payload and a constellation of satellites. (5) Gateways that connect the satellite or aerial access network to a core network. (6) Feeder links that refer to the radio links between the gateways and the space/airborne platform.

In some implementations, satellite or aerial vehicles generate several beams over a given area. The footprint of the beams is typically elliptic in shape. The beam footprint may move over the earth with the satellite or the aerial vehicle moving in orbit. Alternatively, the beam footprint may be earth fixed (for example, covering an earth-fixed cell or service area). In such cases, some beam pointing mechanisms (mechanical or electronic steering feature) can compensate for the satellite or the aerial vehicle motion.

As an example, 3GPP TS 38.300 defines three types of service links: earth-fixed, quasi-earth-fixed, and earth-moving. Earth-fixed service link is provided by the beam(s) that continuously cover the same geographical areas. This is typically observed with geostationary orbit (GSO) satellites. Quasi-earth-fixed service link is provided by the beam(s) that cover one geographic area for a limited period and then cover a different geographic area during another period. This is often seen with non-geostationary orbit (NGSO) satellites that generate steerable beams. Earth-moving service link is provided by the beam(s) whose coverage area moves over the Earth's surface. NGSO satellites can generate fixed or non-steerable beams that slide across the ground. The technologies disclosed herein are directed to the scenario of quasi-earth-fixed service links. The term “earth-fixed” is used below instead of “quasi-earth-fixed” for simplicity.

In the earth-fixed scenario, a satellite can employ a steerable beam to serve and cover a specific geographic area for a limited duration. Beamforming techniques can be employed to provide higher data rates in the higher frequency bands such as Ku and Ka bands. To achieve this, an active phased array antenna can be used to form a steerable beam that serves an earth-fixed cell. However, it is important to note that the size and shape of the beam footprint on the Earth's surface may vary over time due to some factors, including changes in elevation angles, beam steering angles, and satellite movement.

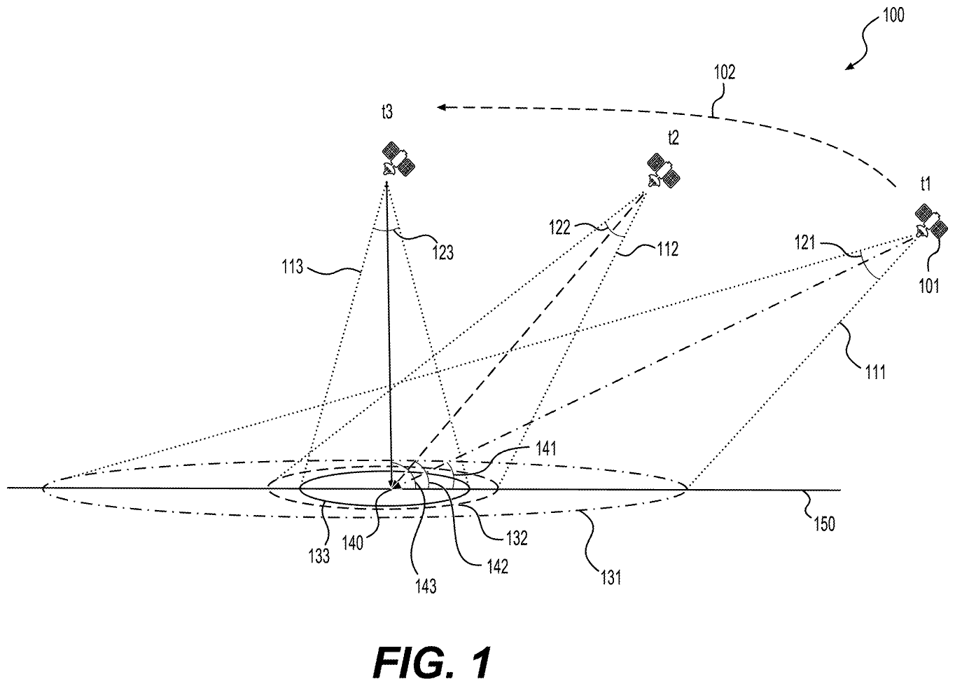

Variations in beam footprint over time can be observed in various scenarios. FIG. 1 shows a first scenario where the beamwidth is fixed, and the size and shape of the beam footprint change with different elevation angles. As shown, a satellite 101 passes three different positions along its orbit 102. At times T1, T2, and T3, the satellite 101 transmits three beams 111-113 having equal beamwidth 121-123, respectively. The three beams 111-113 have three beam footprints 131-133, respectively, covering three areas centered at the same reference point 140. The reference point 140 is located on a ground track 150 of the satellite 101. Three elevation angles 141-143 with respect to the reference point 140 correspond to the three positions of the satellite 101. The sizes and shapes of the three beam footprints 131-133 change with different elevation angles 141-143.

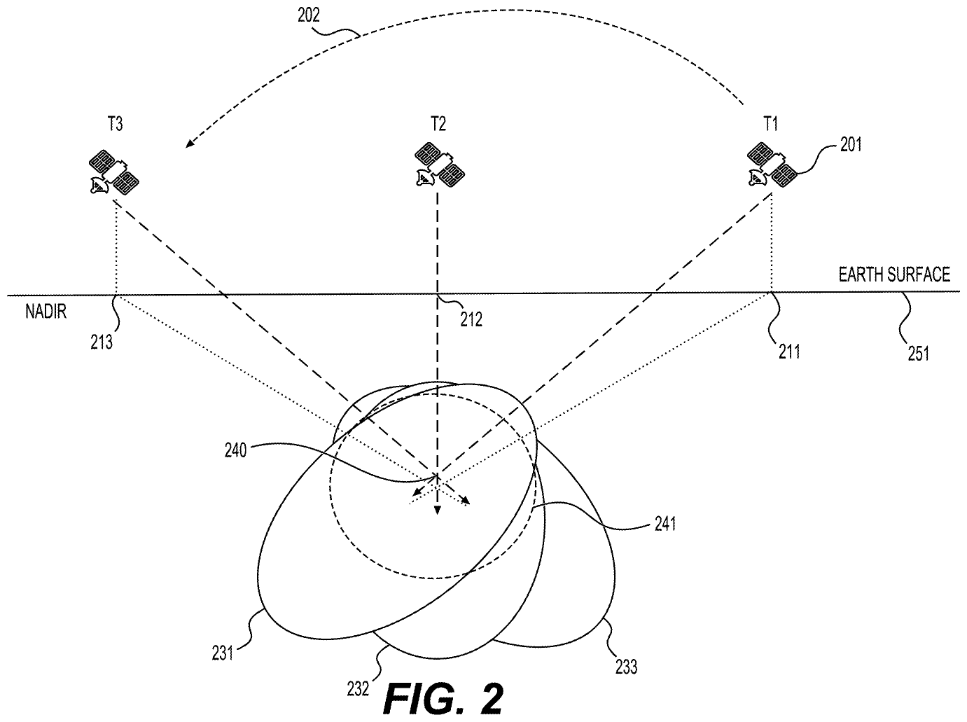

FIG. 2 shows a second scenario where the azimuth angle of the beam changes, and the location, size, and shape of the beam footprint on the ground also change. As shown, a satellite 201 passes three positions along its orbit 202. The three positions correspond to three nadirs 211-213 distributed on the Earth surface 251. At times T1, T2, and T3, the satellite 201 transmits three beams having footprints 231-233. The footprints 231-233 overlap at a region 241 centered at a reference point 240. When the azimuth angles of the beams with respect to the reference point 240 change, the locations, shapes, and sizes of the respective beam footprints 231-233 change on the ground.

In a third scenario, if a phased array is used at a satellite, the beamwidth becomes larger as the steering (or scanning) angle increases, assuming the number of active antenna elements is constant. The beam footprint can vary due to the changing beamwidth.

Beam footprint variation can negatively affect the performance of an NTN. For example, the variation in the serving beam for a UE over time can result in increased handover or cell reselection (beam switching) rates. This can lead to higher signaling overhead, service interruptions, and increased power consumption for UEs. Additionally, there is a potential for interference between different beams, which may disrupt the performance of other beams. To mitigate these issues, it may be necessary to increase the frequency reuse factor (N), which in turn reduces the overall system capacity. Furthermore, if the frequency is shared between the terrestrial network and the NTN, beam footprint interference can affect the terrestrial network. To address these challenges, it is advantageous to maintain a fixed footprint size (and location and shape) to provide consistent cell coverage. This can be achieved by minimizing the stretch of the beam footprint, which is determined by the steering angle and beamwidth.

The present disclosure provides beam management methods to minimize the variation of the beam footprint and realize a fixed cell coverage. A fixed cell coverage or a fixed (or constant) beam footprint means variation of a size of the beam footprint is controlled to be within a certain range. The size of the beam footprint in this disclosure can mean the size, the location, and the shape of the beam footprint. For example, a fixed beam footprint can mean that a distance between a position on the border of the beam footprint and a reference point varies between two distance thresholds. The reference point, for example, can be a center of a target service area, or can be a location predefined. Or, in other words, a fixed or constant beam footprint means a variation of the distance between the position on the border of the beam footprint and the reference point is below a threshold.

In some embodiments, such methods can include the following steps: (1) Beam management preparation for preparing the necessary configurations and parameters for beam management. (2) Beam initialization for initializing the beams based on associated parameters and configurations. (3) Beam adaptation for adapting the beams dynamically to maintain a fixed cell coverage (beam footprint) to account for changing satellite positions or target serving areas. (4) Beam switching for supporting UE switching between beams from different satellites. The method can be implemented to optimize beam management, reduce interference, minimize service disruptions, and enhance overall network efficiency.

### 1. EXAMPLE: Steerable Beams and Earth-Fixed Cells

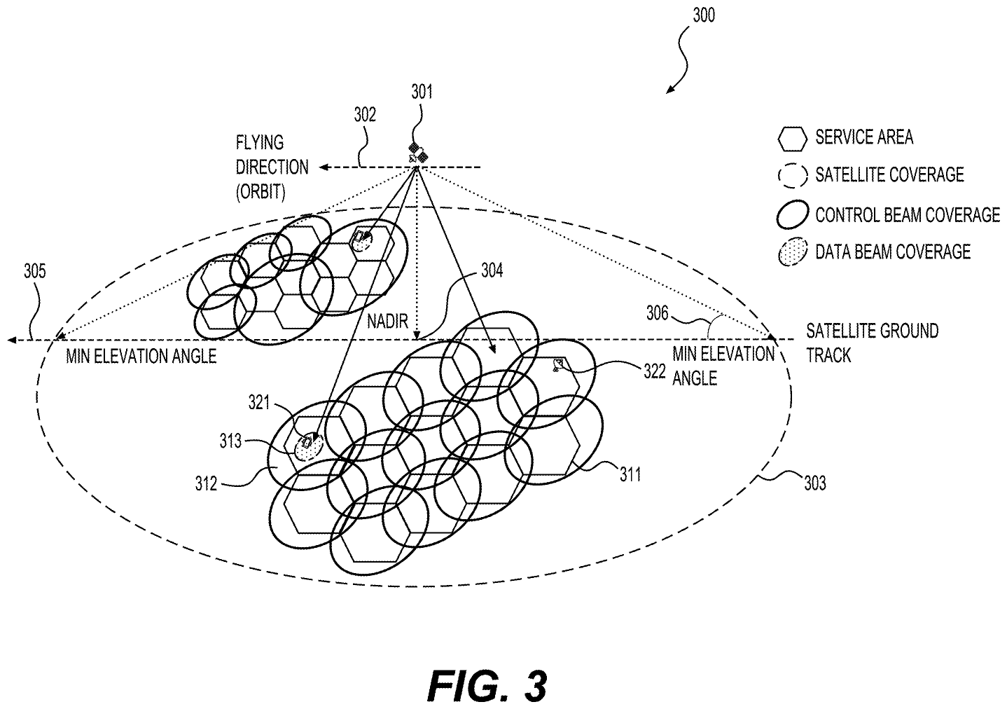

FIG. 3 shows an example of an NTN 300 according to embodiments of the disclosure. A satellite 301, such as an LEO satellite, flies along its orbit 302. The satellite 301 has a nadir 304 on its ground track 305. The satellite 301 has a satellite coverage 303. For example, the satellite coverage 303 can be defined by a border beyond which an elevation angle would be smaller than a threshold, such as a minimum elevation angle 306. Within the satellite coverage 303, regions to be served by the satellite 301 can be partitioned into service areas 311. The service areas 311 can belong to different earth-fixed cells. One earth-fixed cell can include or cover one or multiple service areas 311.

The satellite 301 can employ steerable transmission and/or reception beams to serve the service areas 311. For example, wide control beams can be used to transmit signaling information. Each control beam can form a control beam coverage 312 to cover one or mor service areas 311. Narrow data beams can be used to transmit data information. Each data beam can form a data beam coverage 313 to cover a portion or a whole of a service area 311. The control beams and data beams can be generated in manners of time division multiplexing (TDM) and/or frequency division multiplexing (FDM) to serve the service areas 311. FIG. 3 also shows USs 321 and a telemetry, tracking and command (TT&C) system 322 for tracking and controlling the satellite 301.

### 2. EXAMPLE: Beam Management for Earth-Fixed Cell

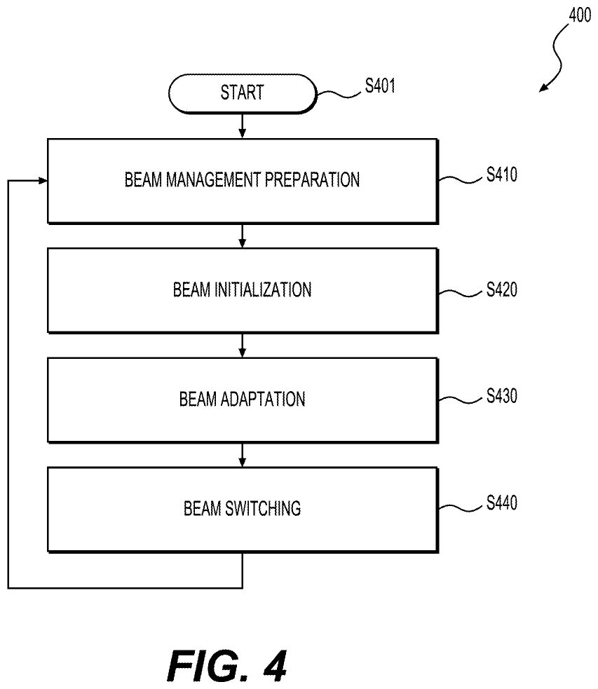

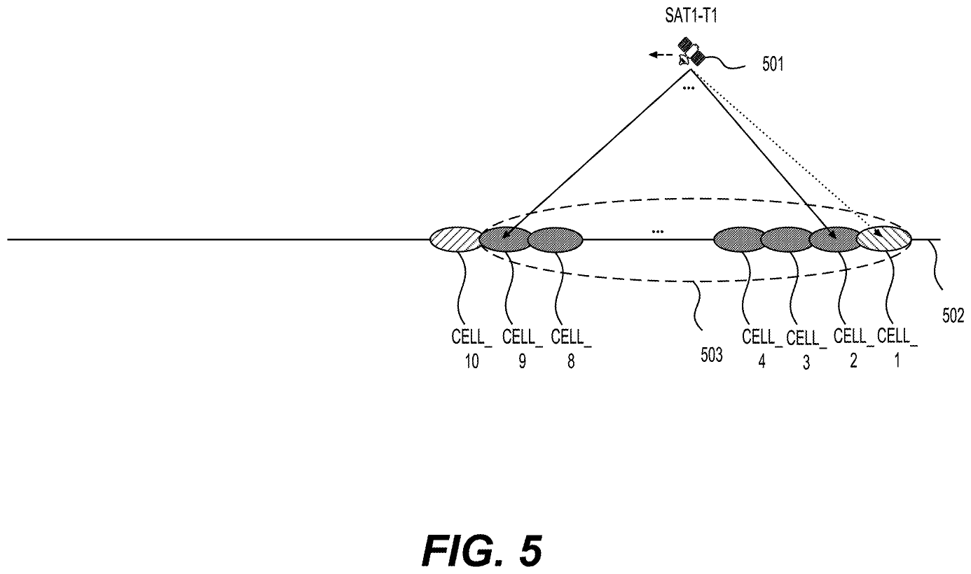

FIG. 4 shows a beam manage process 400 for serving an earth-fixed cell according to embodiments of the disclosure. FIGS. 5-8 illustrates a sequence of a satellite 501's operations at different time points from T1 to T10. The process 400 is explained with reference to FIGS. 5-8. The process 400 starts from S401 and proceeds to S410.

At S410, beam management preparation is performed. Before a satellite payload onboard the satellite 501 starts to serve a target service area, a controller on board the satellite 501 can acquire beam configurations for setting beams transmitted by the satellite 501. For example, in FIG. 5, the controller prepares for serving Cell_10 before T1 and stops serving Cell_1 at T1. As shown in FIG. 5, before time T1, the satellite 501 serves earth-fixed cells from Cell_1 to Cell_9. The earth-fixed cells from Cell_1 to Cell_9 are within a coverage 503 of the satellite 501 and along a ground track of the satellite 501.

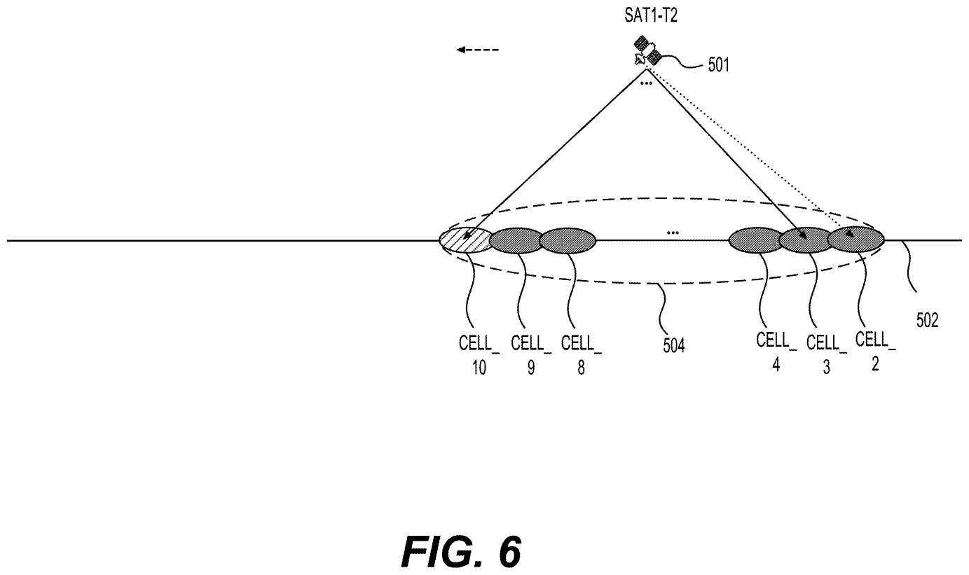

At S420, beam initialization is performed. Based on a to-be-served service area (a target service area) and the satellite position, the controller can select a subset of beam configurations from the beam configurations obtained at S410 to serve the to-be-served service area. For example, in FIG. 6, the satellite 501 starts to serve a target service area, Cell_10, at time T2. As shown in FIG. 6, by the time T2, the satellite 501 serves earth-fixed cells from Cell_2 to Cell_10. The earth-fixed cells from Cell_2 to Cell_10 are within a coverage 504 of the satellite 501 and along the ground track of the satellite 501.

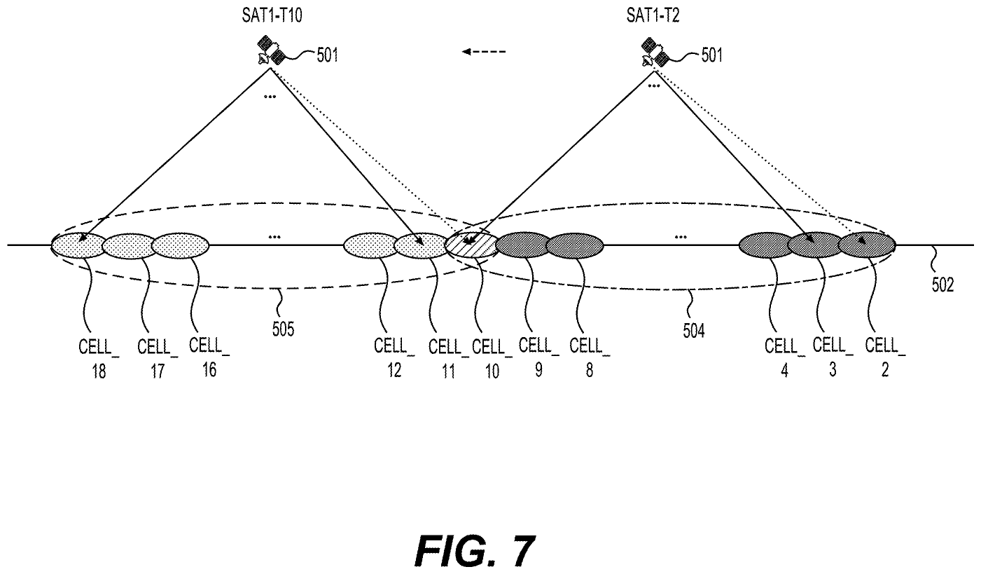

At S430, beam adaptation is performed. While the satellite 501 is serving the target service area (Cell_10), the controller can adapt the beam configuration according to the satellite position or the system time. For example, among the subset of beam configurations determined at S420, the controller can suitably sequentially apply a sequence of beam configurations while the satellite is passing different positions to maintain a fixed beam footprint covering the target service area. For example, in FIG. 7, from time T2 to time T10, the satellite 501 is moving from the right side to the left side. The coverage of the satellite 501 continuously changes from the coverage 504 to the coverage 505. By applying different beam configurations, the controller can control the footprints of a sequence of beams covering Celli® to have a constant or near-constant location, shape, and size.

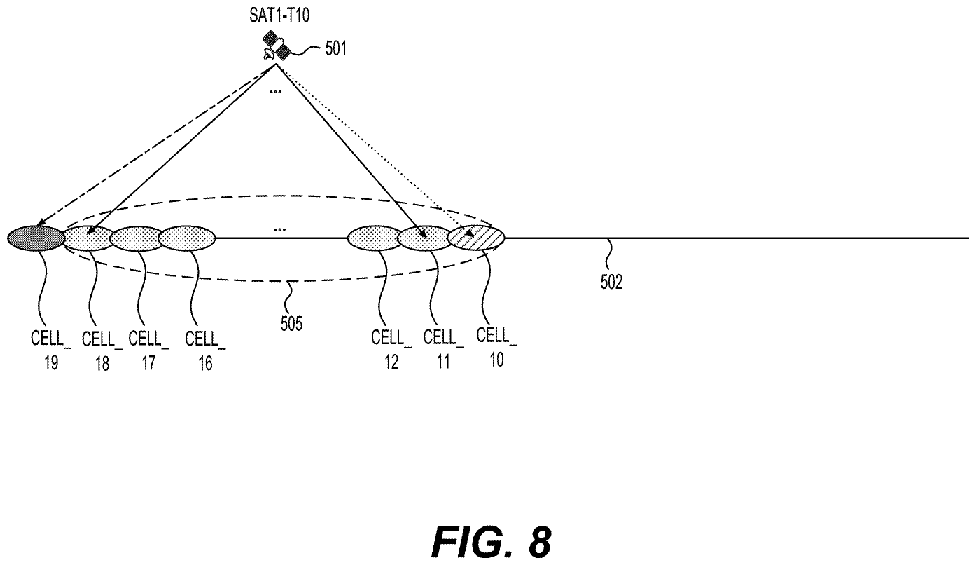

At S440, beam switching is performed. While the beam coverage of the target service area is moving away from the target service area, the controller can take action to handle the UEs left in the service area. For example, the controller may perform the following operations: handover a connected UE to another beam/cell; send a conditional handover command to a connected UE; or, broadcast an assistance information for a UE to do beam/cell reselection. For example, in FIG. 8, before time T10, the controller can take action to prepare for switching the beam from the satellite 501 to a next service area, Cell_19. From the UE perspective, the UEs in Celli® can prepare to switch to another beam from another satellite (if available). Thus, beam switching can happen for the satellite 501 and the UEs. By the time T10, the satellite 501 can start to prepare for serving the new service area, Cell_19. Accordingly, the process 400 can proceed to S410, and the steps of S410-S440 can be repeated.

II. Beam Management Preparation

1. Beam Management Preparation Operations

As described above, at the step S410 of beam management preparation during the beam management process 400, the controller can obtain beam configuration information for setting beams. The beam configuration information can include a portion or all of: (i) information of a target service area, (ii) a set of beam configurations, (2) one or more beambooks corresponding the target service area. For example, a beam configuration can provide parameters useful for the satellite 501 to form a beam with the intended size, shape, and direction, such that the location, size, and shape of the respective footprint can be controlled to maintain a fixed cell coverage. For example, a beam configuration can include amplitude and phase information corresponding to respective antenna elements in an antenna array. For example, a beam configuration can include a precoder for digitally controlling beam forming with one or more antenna arrays. In some examples, a beam configuration may also contain the transmitting power of the beam or antenna array.

In some examples, a part or all of the beam configuration information can be received from a ground station, a gateway station, a TT&C system, and the like. In some examples, a part of the beam configuration information can be derived or generated by the controller. For example, the beambooks can be generated by the controller based on the information of the target service area and the set of beam configurations received from, for example, a ground station. In some examples, the beambooks can be received from, for example, a ground station.

For example, in order to obtain the beam configuration information, the satellite 501 approaching a ground station may connect to the ground station when the satellite reaches a first predefined minimum elevation angle viewed from the ground station. Similarly, the satellite 501 approaching a gateway station may connect to the gateway station when the satellite reaches a second predefined minimum elevation angle viewed from the gateway station. For example, the gateway station information (e.g., location) is contained in the beam configuration received previously.

In some examples, a target service area can be a region served by a control beam. The target service area can include one or more sub-service areas. In some examples, a target service area can be a region served by a data beam. In some examples, the location and size of a target service area can be determined based on a user service subscription (e.g., whether a user subscribed the service), an NTN deployment policy (e.g., whether a region is to be served by the NTN), transmission/reception scheduling, and the like. In some examples, how a target service area is served can be based on beam scheduling or beam policy. For example, a target service area can be served by beam hopping, beam sweeping, periodical serving, and the like. In some examples, a target service area can be represented by a reference location and a radius or an index which indicates a predefined area on the earth surface.

In some examples, the beambooks are employed. The control beam and data beam within the system can utilize different beambooks, allowing for independent control and optimization. A beambook may include parameters specific to steering angles (elevation and azimuth) of the respective beams. A beambook can include amplitudes and/or phases/delays for individual antenna elements in an antenna array.

A beambook can be designed for controlling the size or location of the beam footprint, achieved, for example, by selectively activating or deactivating certain antenna elements or tuning the amplitude and phase/delay of each antenna element.

A beambook may also include information related to the transmitting power of each antenna element or the total transmitting power across all antenna elements in one or more antenna arrays. The transmitting power for each antenna element can be adjusted based on various factors. For instance, the power for each antenna element may be set to be proportional to the total power divided by the number of active antenna elements.

In addition to beam-specific parameters, a beambook may incorporate the satellite's position and/or time references, such as system time or Coordinated Universal Time (UTC). The satellite 501 can accordingly select an appropriate configuration for each antenna element corresponding to a specific position or time reference.

2. Beambook Designs

(A) Beambook Examples

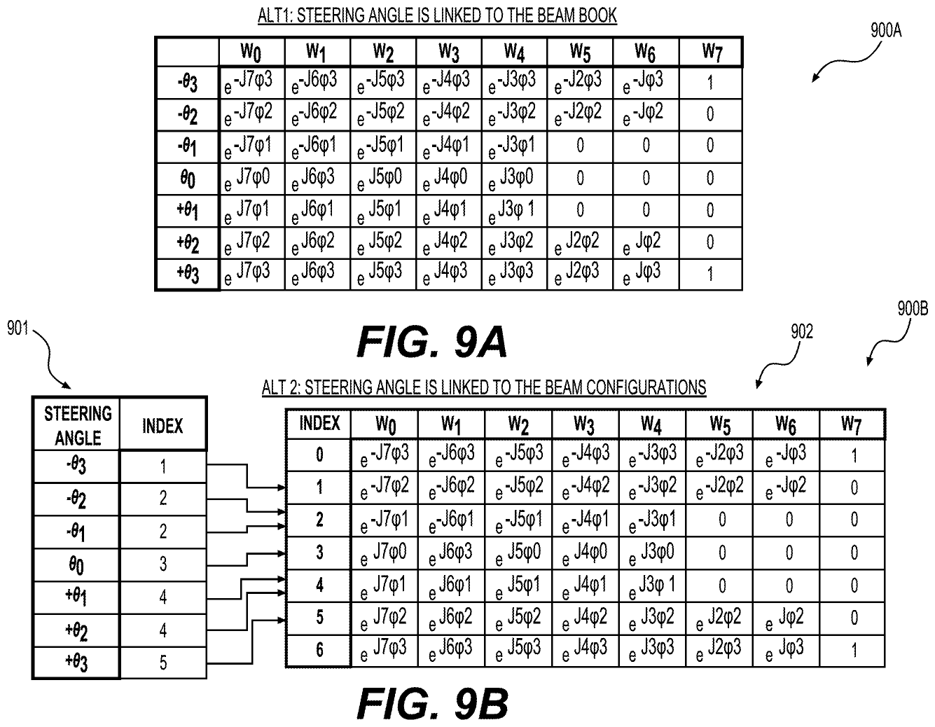

FIG. 9A shows an example of a beambook 900A. The beambook 900A has two dimensions. The first dimension is a sequence of antenna weights applied to input signals to a number of antenna elements in an antenna array in the row direction. The second dimension is a sequence of steering angles of transmission (or reception) beams. As an example, eight weights from w0 to w7 are listed in the horizontal dimension and seven steering angles from −θ3 to +θ3 are listed in the vertical dimension. In each row and corresponding to each steering angle, a sequence of antenna weights is provided corresponding to each respective antenna element. The parameters of such a sequence of antenna weights can be a beam configuration or a part of a beam configuration. Such a beam configuration can be employed to form a beam having the respective steering angle.

As an example, the antenna weights shown in FIG. 9A are weights derived based on the model of a uniform linear array (ULA). For example, the phase factor φ in each weight can be determined as follows:

$$\\ φ = 2 π \frac{d sin ( θ )}{λ} ,$$

where ci denotes a distance between two neighboring antenna elements in the uniform linear array. θ denotes a steering angle of the uniform linear array, and λ denotes a wave length corresponding to the frequency the uniform linear array operates on.

As shown, the phase values of the weights corresponding to a specific steeling angle are shifted. Also, the amplitude values of the weights are set to be either 1 or 0. For example, for used or activated antenna elements, the amplitude can be set to be 1, while for unused or deactivated antenna elements, the amplitude can be set to be 0. Further, the beambook presents a symmetric structure. For example, the two steering angles complementary with each other (e.g., −θ3 and +θ3) have the same set of weight values. When storing the beambook, only one set of weight values are stored for the pair of complementary steering angles to save storage memory. In addition, in other examples, instead of representing the weights with parameters of amplitudes and shifted phases, a weight in a beambook can be represented with parameters of (amplitude, delay). For example, the delay can be represented by

delay=phase/(2*pi*carrier frequency).

FIG. 9B shows another beambook 900B that can be an alternative to the beambook 900A in FIG. 9A. The beambook 900B can include two portions: a beam index book 901 and a beam configuration book 902. The beam index book 901 includes a sequence of steering angles each associated with a beam configuration index. The beam configuration book 902 includes a sequence of rows of beam configurations, each row assigned a beam configuration index. Via the beam configuration indexes, the steering angles in the beam index book 901 are linked to the beam configurations in the beam configuration book 902. As shown, different steering angles can be linked to a same beam configuration.

For example, when the beambook structure in FIG. 9B is used, multiple service areas that are to be served by a satellite can each have a beam index book. These beam index books of the multiple service areas can share a same beam configuration book. The beambook 900A in FIG. 9A can be formed and used for a specific service area where each steering angle is associated with a beam configuration.

In some examples, a steering angle in the beambook 900A or 900B can be interpreted as a range or can represent a range. For example, θ1 can be interpreted as a range between θ1 and θ2 or represent a range between θ1 and θ2. For example, for covering a service area at a time instance, the satellite may determine a suitable steering angle for beam forming. If such an exact steering angle is not in the beambook, a range of steering angle including such a steering angle can be found. The beam configuration corresponding to the range can be used for the beam forming.

FIGS. 10A-10B shows another two examples of beambooks 1000A-1000B. The beambooks 1000A-1000B have similar structures as the beambooks 900A-900B, respectively. However, the locations from L1 to L7 are used in place of the steering angles from −θ3 to +θ3. For example, to cover a specific service area, at a specific location, a corresponding beam configuration can be determined based on the beambook 1000A or 1000B. At the location changes, the satellite can obtain the respective beam configurations to perform beamforming to form a beam footprint with constant size, shape, and/or location. Similarly, a location in the beambooks 1100A-1100B can be interpreted as a range of locations or can represent a range of locations.

FIGS. 11A-11B shows another two examples of beambooks 1100A-1100B. The beambooks 1100A-1100B have similar structures as the beambooks 900A-900B, respectively. However, the time points from T1 to T7 are used in place of the steering angles from −θ3 to +θ3. For example, to cover a specific service area, at a specific time, a corresponding beam configuration can be determined based on the beambook 1100A or 1100B. As time changes, the satellite can obtain the respective beam configurations to perform beamforming to form a beam footprint with constant size, shape, and/or location. Similarly, in some examples, a time in the beambooks 1100A-1100B can be interpreted as a range of times or can represent a range of times.

Generally, a beambook with specific structures can function as a lookup table for proving a sequence of beam configurations. The sequence of beam configurations can be used, for example, in the process of beam adaptation for maintaining a fixed-sized beam footprint over an earth-fixed cell. A beam reference parameter (such as a steering angle, a time, a location (a satellite location), and the like) can be used as an input value or a key to search for a beam configuration in the beambook. (The beam reference parameter can be referred to as a beam configuration reference.) In the beambook, a sequence of beam reference parameters can each be associated with a beam configuration. The association can be either a direct association as in the examples of FIGS. 900A, 1000A, and 1100A, or based on a beam configuration index as in the examples of FIGS. 900B, 1000B, and 1100B.

In addition, a beam configuration corresponding to a beam reference parameter may take various forms that may be the same as or different from what is shown in the examples of FIGS. 9A/9B/10A/10B/11A/11B. For example, the weights may be derived based on models other than the ULA model, and thus have different forms. In some examples, the beam configurations may not be based on the weights of antenna elements. For example, the beam configuration may include a multi-antenna precoder for digitally forming a beam. The beam configuration may include a combination of one or more multi-antenna precoders and one or more weights for antenna elements, such that the beam can be formed in a hybrid manner (digital and analog beam forming).

(B) Example of Beambook Storage and Retrieval

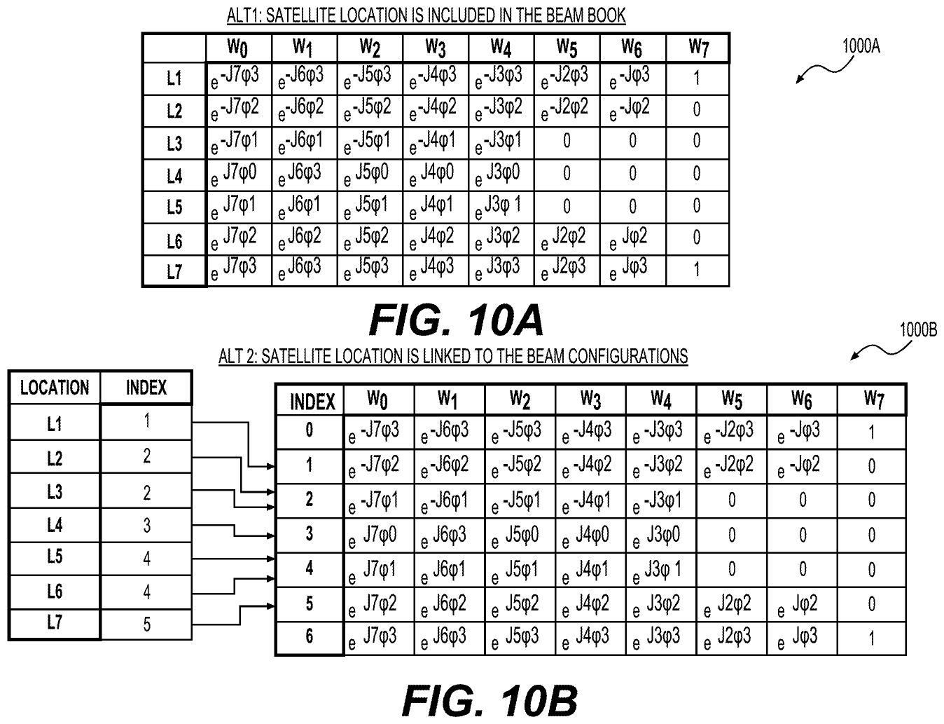

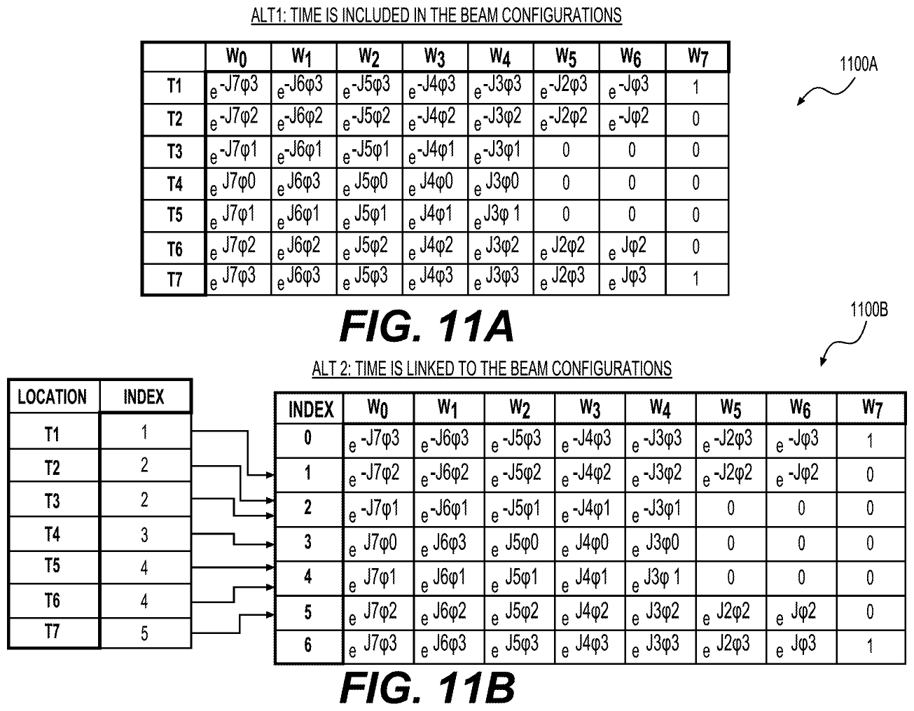

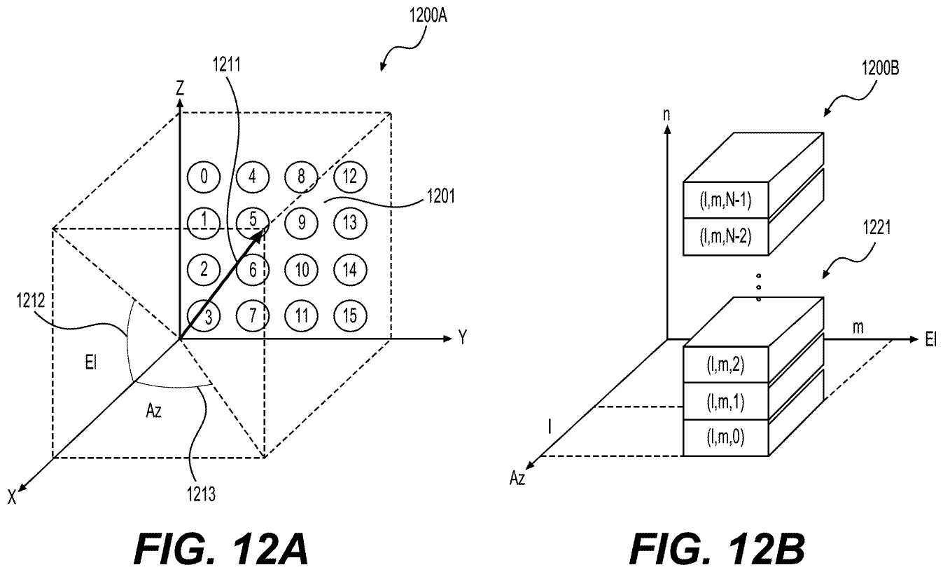

FIG. 12A shows a coordinate system 1200A having x, y, and z axes. A satellite can be positioned at the original point of the coordinate system 1200A. The x-axis can be perpendicular to the ground surface. The x-z plane can pass the Earth axis. The y-axis can be towards the eastern direction. A steering direction 1211 of the satellite is represented by the vector 1211. The steering direction 1211 can be defined by an elevation angle 1212 and an azimuth angle 1213 shown in FIG. 12A. The satellite can carry an antenna panel having 16 antenna elements, N=16. The antenna elements are numbered from 0 to 15.

Given the above definitions of azimuth and elevation, and the numbering of the antenna elements, a beambook can be stored in a three-dimensional (3D) table 1200B shown in FIG. 12B. The 3D table 1200B can have three dimensions representing the indices of azimuth, elevation, and antenna elements. The three types of indices are denoted by 1, m, and n, respectively. Each azimuth index can correspond to a specific azimuth value or a range of azimuth values. Each elevation index can correspond to a specific elevation value or a range of elevation values. Thus, 1 and m can be uniquely determined given azimuth and elevation angles of a specific steering angle. Given 1 and m, a weighting vector 1221 can be precalculated (considering forming a constant beam footprint) and stored:

[(1,m,0),(1,m,1),(1,m,2), . . . ,(1,m,N-2),(1,m,N)]

where N denotes the total number of antenna elements. Each element in the weighting vector 1221 is a weight to be applied to the input signal to the respective antenna element. Accordingly, each weighting vector in the 3D table in FIG. 12B can serve as a beam configuration.

The 3D table 1200B containing the beam configurations can serve as a wholistic beambook and stored in a memory. Other beambooks corresponding to a sequence of steering angles, times, or locations (such as shown in FIGS. 9A/9B/10A/10B/11A/11B) can be derived from the wholistic beambook. For example, the wholistic beambook 1200B can be used as the beam configuration book 902. The beam index book 901 can include beam confirmation indices pointing to associated beam configurations in the wholistic beambook 1200B. It can be seen, the combination of a beam index book with a beam configuration book can save storage, because different beam index books corresponding to different service areas can share a same wholistic beambook 1200B while the satellite flying in space and serving the different service areas at the same time.

For example, at a specific time or location, to steer a beam to a given azimuth and elevation angles, the controller can map the azimuth and elevation angles to indices land m, respectively. The controller can then retrieve the values of the weighting vector along the n axis. Subsequently, the controller can apply the weighting vector to an RF chain of the corresponding antenna elements. In some cases, some of the RF chains can be turned off to adjust the beamwidth (e.g., beam shape).

(C) Example of Generation of 2D Weighting Vector

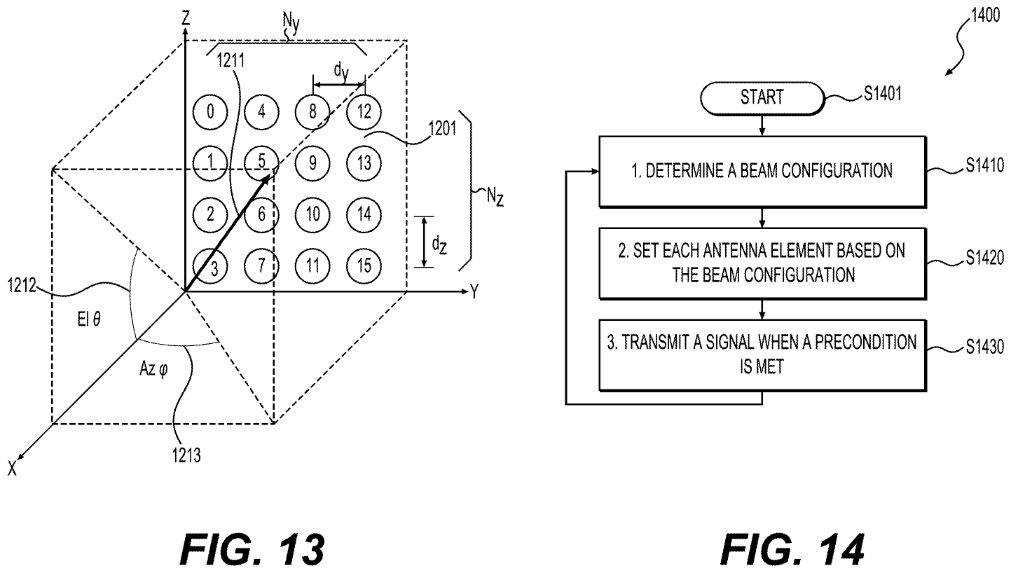

FIG. 13 shows the same coordinate system as in FIG. 12A but with additional parameters. The elevation angle is denoted by θ. The azimuth angle is denoted by cp. The elevation angle and the azimuth angle together represent a steering angle. The horizontal size and the vertical size of the antenna panel 1201 are denoted by Ny and Nz, respectively. The distances between neighboring antenna elements in the horizontal and vertical directions are denoted by dy and dz, respectively.

Given the above parameters, a weighting vector can be generated using Kronecher product as follows. Phase increment along y axis can be represented as

$$\\ {s}_{y , {n}_{y}} = {e}^{j 2 π {n}_{y} \frac{{d}_{y}}{λ} sin φ} , where {n}_{y} = 0 , 1 , … , {N}_{y} - 1.$$

Phase increment along z axis can be represented as

$$\\ {s}_{z , {n}_{z}} = {e}^{j 2 π {n}_{z} \frac{{d}_{z}}{λ} sin θ} , where {n}_{z} = {N}_{z} - 1 , {N}_{z} - 2 , … , 0.$$

Weighting vector along y axis can be represented as

s_{y}=[s_{y,0}s_{y,1}. . . s_{y,N}_{_{y}}_{-1].}

Weighting vector along z axis can be represented as

s_{z}=[s_{z,0}s_{z,1}. . . s_{z,N}_{_{z}}_{-1]}^{T}.

The Kronecker product can be generated as follows:

$$\\ S = {s}_{z} ⊗ {s}_{y} = [ \begin{matrix}{s}_{z , 0} {s}_{y , 0} & {s}_{z , 0} {s}_{y , 1} & ⋯ & {s}_{z , 0} {s}_{y , {N}_{y} - 1} \\ {s}_{z , 1} {s}_{y , 0} & {s}_{z , 1} {s}_{y , 1} & ⋯ & {s}_{z , 1} {s}_{y , {N}_{y} - 1} \\ ⋮ & ⋮ & ⋱ & ⋮ \\ {s}_{z , {N}_{z} - 1} {s}_{y , 0} & {s}_{z , {N}_{z} - 1} {s}_{y , 1} & ⋯ & {s}_{z , {N}_{z} - 1} {s}_{y , {N}_{y} - 1}\end{matrix} ] = [ \begin{matrix}{w}_{0} & {w}_{{N}_{z} + 0} & ⋯ & {w}_{{N}_{z} \cdot ( {N}_{y} - 1 ) + 0} \\ {w}_{1} & {w}_{{N}_{z} + 1} & ⋯ & {w}_{{N}_{z} \cdot ( {N}_{y} - 1 ) + 1} \\ ⋮ & ⋮ & ⋱ & ⋮ \\ {w}_{{N}_{z} - 1} & {w}_{2 {N}_{z} - 1} & ⋯ & {w}_{{N}_{z} \cdot {N}_{y} - 1}\end{matrix} ]$$

The waiting vector can be w=[w₀ w₁ w_{N}_{_{z}}_{·N}_{_{y}}₋₁]. The waiting vector can serve as a beam configuration and stored in the 3D table 1200B.

(D) Generation and Usage of a Beambook

A beambook can be generated through the following steps by a controller: (i) Determining a reference location of a service area and the current position of the satellite; (ii) Generating a steering angle based on the reference location and satellite position. (iii) Determining a specific set of beamforming parameters for each antenna element based on the steering angle. These parameters are selected in such a way that the resulting beam's footprint size is smaller than a predefined first threshold. The specific set of beamforming parameters (e.g., weights) for each antenna element can be grouped as a beam configuration corresponding to the steering angle. For example, a wholistic beambook (e.g., the 3D table 1200B) can be predetermined and provided to the controller. The controller can select a beam configuration from the wholistic beambook based on the known steering angle of the current satellite position. The beambook can take at least one the two forms: (a) beam configurations are included in the beambook (e.g., beambook 900A/1000A/1100A), or (b) beam configuration indices are included in the beambook (e.g., the beam index book 901 or the beam index books in FIGS. 10B and 11B). (iv) For different positions on the orbit of the satellite, corresponding to the same reference location of the service area, a sequence of beam configurations can be determined according to steps (i)-(iii). Those sequence of beam configurations can form a beambook for serving the targeted service area.

The set of beamforming parameters for each antenna element can include one or more of the following: an on/off indication (to activate or deactivate the element), amplitude and phase, or amplitude and delay.

The size of the beam's footprint can be determined by the beamwidth, which is based on the steering angle and the set of beamforming parameters assigned to each antenna element, as well as the satellite's altitude. The beam footprint size may exceed a second threshold to ensure coverage of the desired service area.

When selecting antenna elements to be set as inactive or unused, preference may be given to elements located at the end of the antenna array in some examples.

3. Further Examples of Beam Management

(1) Beam Management

A first method of a controller managing a beam can include obtaining a multiple sets of configurations by the controller for setting the beam before a satellite starts to serve a service area; selecting a set of configuration from the multiple sets of configurations by the controller to serve the service area according to the service area and a satellite position; and adapting the beam configuration based on the set of configuration according to the satellite position or a system time. In an embodiment, the first method further includes handling the UE in the service area before the beam coverage is moving out of the service area. In an embodiment, the handling the UE further includes handing over a connected UE to another beam/cell; sending a conditional handover command to a connected UE; or broadcasting an assistance information for a UE to do beam/cell reselection.

(2) Beam Preparation

A second method for a controller managing a beam can include obtaining multiple sets of configurations for serving a service area before a satellite starts to serve a service area, wherein the set of configuration comprises the service area.

The second method can further include obtaining a set of beambooks; storing the set of beambooks in a memory; and determining a beambook according to the service area. The second method can further include generating a beambook according to the service area; and storing the set of beambooks in a memory. The second method can further include connecting to a ground station when the satellite reaches a first predefined minimum elevation angle viewed from the ground station. The second method can further include connecting to a gateway station when the satellite reaches a second predefined minimum elevation angle viewed from the gateway station, wherein the gateway station information is contained in the set of configurations.

In an embodiment, the service area is further determined by a user service subscription, a deployment policy, or a scheduling; and served by the beam based on the scheduling. The service area is further represented by a reference location and a radius; or index which indicates a pre-defined area on an earth surface. In an example, the set of configurations further comprises a transmitting power.

In some examples, the beambook further comprises a steering angle or (el, az) angle; and an amplitude and phase/delay for each antenna element. In some examples, the beambook further comprises a satellite position or a system time; and an amplitude and phase/delay for each antenna element. In some examples, the beambook further comprises an amplitude and phase/delay for each antenna element. In some examples the beambook further comprises a transmitting power for each antenna element.

(3) Beambook Generation

A third method of generating a beambook can include determining a reference location and a satellite position; generating a steering angle based on the reference location and the satellite position; and determining a set of beamforming parameters for each antenna element based on the steering angle such that a beam footprint size of the beam is less than a first threshold. In some examples, the set of beamforming parameters for each antenna element includes an on/off (active/inactive) indication; amplitude and phase; or amplitude and delay.

In some examples, the beam footprint size can be further determined by a beamwidth based on the steering angle and the set of beamforming parameters of each antenna element, and an altitude of the satellite. In some examples, the beam footprint size is larger than a second threshold. In some examples, the amplitude can be further set to a Zero which means the corresponding antenna element is off or inactive. In some examples, the antenna element selected from an end antenna element of an antenna array. In some examples, the beambook includes a set of the steering angles corresponding to a set of the amplitudes for each antenna element; or a set of the satellite positions corresponding to a set of the amplitude for each antenna element. In some examples, the steering angle further comprises an elevation angle and an azimuth angle.

IV. Beam Initialization

1. Beam Initialization Process

FIG. 14 shows a beam initialization process 1400 according to an embodiment of the disclosure. The process 1400 can start from S1401 and include steps of S1410-S1430. Before S1410, a controller on a satellite may perform the following operations to obtain a set of beam configurations. For example, when the satellite's elevation angle reaches a predefined threshold, such as 10 degrees, for a reference point (e.g., TT&C), the controller within the satellite payload establishes a connection with the TT&C system. Alternatively, when the TT&C system detects the presence of the satellite, it establishes a connection with the controller in the satellite payload. The controller can acquire the most recent and updated sets of beam configurations from either the ground station, gateway station, or the TT&C system. An example of the sets of beam configurations is the 3D table 1200B in FIG. 12B.

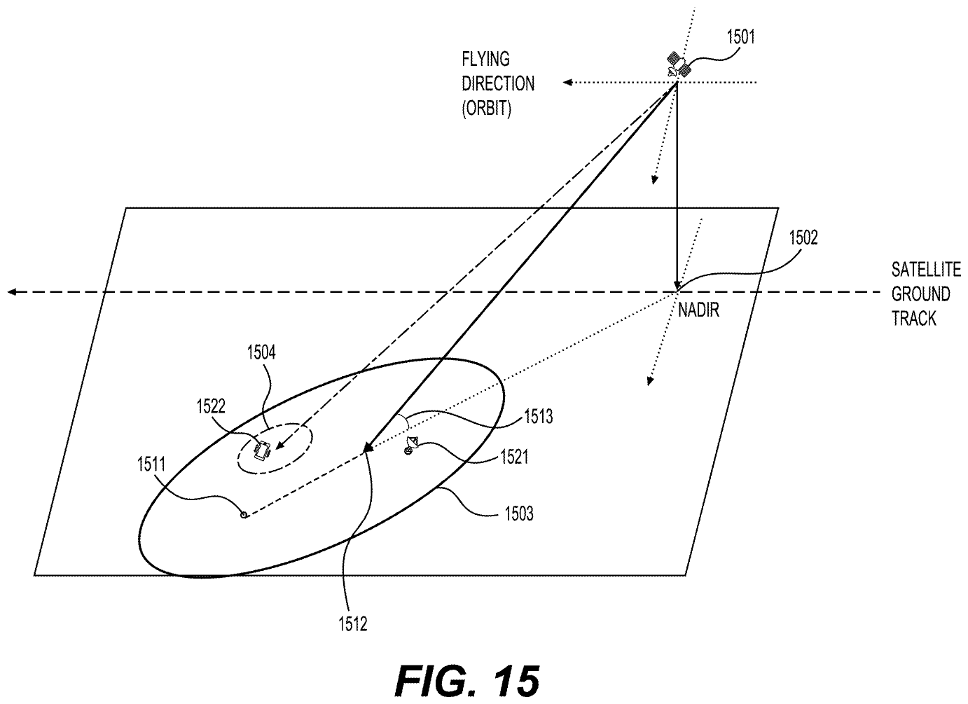

FIG. 15 shows examples of reference points. A satellite 1501 is flying on an orbit and has a nadir 1502 on a ground track of the satellite 1501. The satellite 1501 can transmit a control beam with a beam footprint 1503 and a data beam with a beam footprint 1504. Two reference points 1511-1512 are shown. For example, the reference point 1512 can be located at the center of a target service area, while the reference point 1511 can be located at the edge of the target service area. For the reference point 1512, an elevation angle 1513 is shown. FIG. 15 also shows a UE 1522 within the data beam footprint 1504 and a TT&C system 1521 within the control beam footprint 1503.

At S1410, the controller determines the beam configurations based on the scheduled service area and the satellite's ephemeris/position. For example, for a sequence of positions (or locations, respective times) along the orbit of the satellite, a beam configuration can be determined for each of such positions (or times). In some cases, a beambook can be employed that contains the sequence of beam configuration. In an example, for control beams, the beam configuration can be derived from a beambook and other parameters such as transmitting power. These control beams are utilized for transmission of synchronization signal block (SSB), system information block (SIB), paging, random access channel (RACH), and the like. For data beams, the beam configurations can also be obtained from a beambook and other parameters such as transmitting power. These data beams are used for transmitting physical downlink control channel (PDCCH)/physical downlink shared channel (PDSCH) for user data and other relevant purposes.

At S1420, the controller configures each antenna element based on the determined beam configuration. For example, for the first position or time of the sequence of positions along the orbit of the satellite, the beam configuration can be determined. This beam configuration is applied to the respective RF circuits corresponding to each antenna element of an antenna array.

At S1430, the controller can start the transmission of control or data beams under the certain conditions. Examples of these triggering conditions can include the following scenarios. The satellite's elevation angle reaches a predefined threshold, for example, 30 degrees, relative to a reference point located at the edge or center of the scheduled service area. The beams steering angle reaches a predefined threshold, such as 45 degrees, indicating that the beam is directed towards a reference point within the service area. A data transmission scheduled for a UE in a scheduled area is needed. A control signal is required for a service area. When the satellite arrives at a second point, the steps of S1410-1430 can be repeated. For example, at S1410, at the second location of the sequence of positions, another beam configuration can be selected from the sequence of beam configurations determined previously and used for S1420 and S1430.

In the process 1400, the beambook can be acquired from a server (e.g., connected to or at a ground station or a gateway station) or generated by the controller using information such as the scheduled service area, satellite ephemeris, and the satellite's position. Beambook selection can be determined based on factors including the service location, satellite position, satellite ephemeris, transmission power, and periodic considerations. The beambook can include the following parameters: steering angles, satellite positions, or time; an on/off indication, amplitude and phase, or amplitude and delay for each antenna element; and/or a transmitting power for each antenna element (for example, determined by the number of active antenna element and a total transmitting power).

The steering angle can be represented by both an elevation angle and an azimuth angle. When data transmission is required for a UE, the controller can start to transmit the data beam. For example, the controller can determine a steering angle for the data beam to illuminate the scheduled area based on UE locations. The scheduled area can be a service area or smaller than a service area and contains scheduled UEs. When a control signal transmission is necessary, the controller can start the transmission of signaling with a control beam. To illuminate the required service area, the steering angle for the control beam can be determined.

In some examples, the service/scheduled area, which is covered by the control/data beam, respectively, is determined based on network scheduling. This determination may consider the following factors: (i) The scheduling policy of the gNB (base station). (ii) The subscription address of a user (relevant for fixed services). (iii) The location of UEs requesting data transmission. (iv) The user's service subscription level. (v) The amount of data waiting for transmission, indicated by the buffer status report. Part of the aforementioned information can be provided by a UE, which includes: (i) The location of UEs requesting data transmission. (ii) The user's service subscription level. (iii) The amount of data waiting for transmission, as reported by the buffer status.

2. Beam Configuration Examples

In some examples, according to the steering angle of a beam from the satellite, a controller within the satellite can adjust the beamwidth by selectively activating or deactivating antenna elements. The aim is to ensure that a beam footprint size of the beam falls within a predefined range. For example, increasing the beamwidth can be achieved by deactivating one or more antenna elements. Decreasing the beamwidth can be achieved by activating one or more antenna elements. The adjustment of beamwidth can be based on the target beam steering angle.

A table can be utilized to establish the relationship between the steering angle and the required active antenna elements. The beamwidth adjustment can be based on such a table. For example, the activation or deactivation of antenna elements is determined by comparing the current number of active antenna elements with the required number.

Beamwidth adjustment can also be based on a beambook that includes the relationship between the steering angle and the weight assigned to each antenna element. The weight is used for phase shifting, calculated as the product of amplitude and phase. When an antenna element is turned off, its amplitude is set to 0. When it is turned on, the amplitude is set to 1. The steering angle can be represented by the satellite's location or a corresponding time point. The weight parameter combination of (amplitude, phase) can be replaced by (amplitude, delay). Delay, expressed as delay=phase/(2pi carrier frequency), represents the time delay required and can be calculated based on the phase shift and carrier frequency.

3. Further Examples of Beam Initialization (Control or Data Beam)

(1) Beam Initialization (Control and/or Data Beam)

A method of a controller managing a beam can include determining a beam configuration based on an area and a satellite ephemeris; setting each antenna element based on the beam configuration; and transmitting a signal based on the beam configuration when a predefined condition is met. The determining the beam configuration can be based on a beambook. The beambook can be obtained from a server which maintains a set of beambooks; or generated by the controller based on the service area and the satellite ephemeris. The beambook comprises a steering angle, a satellite position, or time; and an on/off (active/inactive) indication, an amplitude and a phase for each antenna element, or an amplitude and a delay for each antenna element.

The area can comprise a service area wherein the service area is served by a control beam, a scheduled area wherein the scheduled area is served by a data beam. The predefined condition could be when the satellite reaches a predefined minimum elevation angle viewed from a reference point of the service area; when a steering angle of the beam reaches a predefined steering angle, in which the beam is pointing to a reference point of the service area; when a data transmission to a scheduled UE in the scheduled area is needed; or when a control signal to a service area is needed.

In an example, the beam configuration comprises a steering angle or a satellite position for the beam to serve the area; and an on/off (active/inactive) indication for each antenna element. In an example, the beam configuration further comprises a steering angle or a satellite position for the beam to serve the area; and an amplitude and a phase, or an amplitude and a delay for each antenna element, wherein when the amplitude equals to zero, it means that the corresponding antenna element is inactive/off.

The steering angle can be indicated by an elevation angle and an azimuth angle. A transmitting power for each active/on antenna element is determined based on a total transmitting power. The beam configuration can include a transmitting power for each antenna element. The area can be determined based on a scheduling policy of a gNB; a subscription address of a user (for fixed service); at least a position of a UE which requests for data transmission; an amount of data waiting for transmission (a buffer status report); or a user service subscription level.

(2) Beam Initialization (UE Behavior)

A method of a UE assisting beam management can include sending an assistance information to a network. The assistance information can include a position of UE; a user service subscription level; an amount of data waiting for transmission (a buffer status report); or an Indication of whether there is urgent data (or high priority data) for transmission.

III. Beam Adaptation

1. Beam Adaptation Process

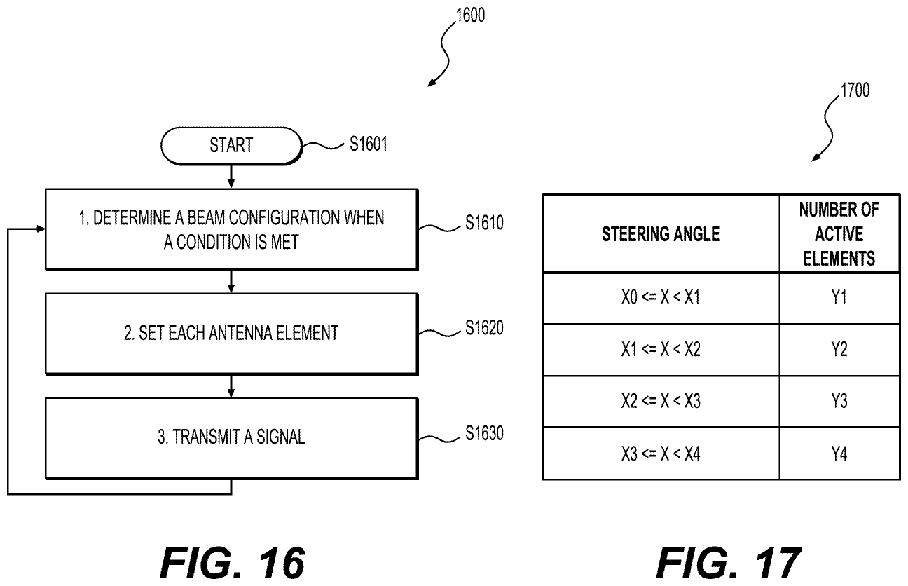

FIG. 16 shows a beam adaptation process 1600 according to an embodiment of the disclosure. While a satellite is flying on an obit and traversing a sequence of positions on the obit, a controller on the satellite can continuously adapt or adjust a control beam or a data beam to maintain a constant beam footprint to cover a target service area or a schedule area. The process 1600 can start from S1601 and proceed to S1610.

At S1610, for a control beam or a data beam, the controller can determine a beam configuration based a target area and a satellite ephemeris (including timing and position information of the satellite). The determination can be performed when a predefined condition is satisfied. Examples of the predefined condition can include a policy, a periodicity (e.g., a periodic timer expiry), a satellite position in a predefined position, a steering angle of the beam reaching a predefined angle, an assistance information reported by a UE meeting a criterion, when a data transmission is needed, or when a control signal transmission is needed.

At S1620, the controller can set or configure each antenna element of an antenna array onboard the satellite based on the beam configuration.

At S1630, based on the step of S1620, the controller can control the antenna array to transmit a signal or a beam based on the beam configuration. The steps of S1610-S1630 can be repeated carried out once the predefined condition is satisfied as described at S1610.

In some examples, the determination of a beam configuration for a control beam at S1610 can include the following operations: (1) Determine a beam footprint location and size based on a service area to be targeted. (2) Determine the steering angle for the beam to illuminate the required service area based on the beam footprint location and/or size. (3) Determine whether the steering angle reaches the predefined angle (e.g., the maximum steering angle for service). If the needed steering angle is larger than the predefined angle, the satellite is unable to cover the target area. (4) Determine whether the beamwidth adjustment is needed, e.g., based on steering angle and beambook, in order to make the beam footprint is less than a threshold (e.g., considering footprint location, size, shape, and the like). For example, in a beambook, steering angles within a specific range may share a same beam configuration. If the current steering angle is within the same range of a previous steering angle, there is no need to adjust the current beam or beamwidth. (5) Adjust the beamwidth, e.g., based on the steering angle and beambook, when necessary. (6) Determine the Tx power and transmit the signal.

In some examples, the determination of a beam configuration for a data beam at S1610 can include the following operations: (1) Determine a beam footprint location and size based on a location(s) of the scheduled UEs to be targeted. (2) Determine the steering angle for the beam to illuminate the scheduled area based on the beam footprint location and/or size. (3) Determine whether the steering angle reaches the predefined angle (e.g., the maximum steering angle for service). If the needed steering angle is larger than the predefined angle, the satellite is unable to cover the target area. (4) Determine whether the beamwidth adjustment is needed, e.g., based on the UE locations, steering angle, and beambook, in order to make the beam footprint is less than a threshold (e.g., considering footprint location, size, shape, and the like) and cover the scheduled area. For example, in a beambook, steering angles within a specific range may share a same beam configuration. If the current steering angle is within the same range of a previous steering angle, there is no need to adjust the current beam or beamwidth. For another example, there is no other service areas neighboring a current service area. Thus, there would be no interference by the current beam to neighboring service areas. Accordingly, beamwidth adjustment may not be necessary. (5) Adjust the beamwidth, e.g., based on the scheduled area, the steering angle, and beambook, when necessary. (6) Determine the Tx power and transmit the signal.

In some examples, a UE can report measurement information or other assistance information to a satellite. That information can be used by one or more satellites to perform beam management (e.g., beam initialization, beam adaptation, beam switch, or the like).

For example, a UE can measure a first reference signal from a first beam from the satellite. The UE may additionally measure a second reference signal from a second beam from the satellite. The UE may calculate a first elevation angle for the satellite. The UE may report assistance information to the satellite. The assistance information can include a first measurement result of the first reference signal and the first elevation angle, a UE location or timing advance (TA) (TA value), a second measurement result of the second reference signal, a UE preference including a list of beam IDs (or cell IDs) which the UE prefers to use, a required service time, and the like.

2. Beamwidth Adjustment

During the beam adaptation process 1600, the beamwidth adjustment is continuously monitored and performed in order to maintain a constant beam footprint. The beamwidth adjustment can include adjustments of the shape and size of the respective beam.

In some examples, the beamwidth adjustment can be based on a steering angle and the number of required active antenna elements. For example, when a steering angle (X) is equal to or greater than X₁, X₂, . . . X_{N} degrees, a controller can adjust the beamwidth to BW₁, BW₂, BW_{N}, respectively. For example, the controller can turn on/off antenna elements to let the number of the active antenna elements equal to a specific number, Yₛ. Specifically, when the steering angle is less than X₁, the number of active antenna element is Y₀. When the steering angle is equal to or greater than X₁ but less than X₂, the controller turns on/off antenna elements and let the number of active antenna elements equal to Y₁.

FIG. 17 shows a table 1700 of [X₁, X₂, . . . X_{N}; Y₁, Y₂, . . . Y_{N}] that maps a sequence of steering angles (or steering angle ranges) with a sequence of numbers of active antenna elements. The table 1700 may be pre-constructed. The table 1700 can be another type of beambook for beam management. The selection of Xₙ and Yₙ can be determined in such a way that, corresponding to a steering angle, the number of active antenna elements can ensure that the diameter of the beam is less than a first threshold, Thres_1, and/or the diameter of the beam is larger than a second threshold, Thres_2. In some examples, turning on/off antenna elements may be performed on the last antenna elements among the ordered and numbered antenna array to make the active antenna elements be consecutive.

In other examples, the beamwidth adjustment or beam adaptation can be based on beambooks as described with reference to FIGS. 9A-11B.

3. Beamwidth Adjustment Process

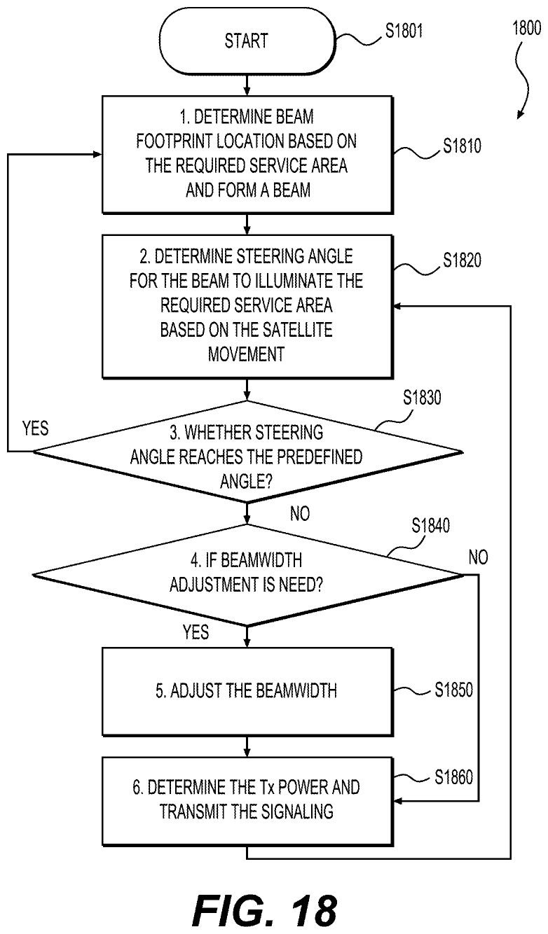

FIG. 18 shows a beamwidth adjustment process 1800 according to an embodiment of the disclosure. The process 1800 starts from 51801 and proceeds to 51810. At S1810, a controller onboard a satellite can determine the beam footprint location based on a target service area (a required service area) and form a beam, e.g., at T2, forming a beam at beam-10 location, as shown in FIG. 6 or FIG. 7. At 51820, the controller can determine a steering angle for the beam to illuminate the required area based on the satellite movement. For example, the satellite moves to a location different from the original location at S1810. At S1830, the controller determines whether the steering angle reaches the predefined angle (e.g., the maximum steering angle for service at T10 in FIG. 8). If so, the process 1800 returns to 51810 to restart the process 1800 targeting another service area. Otherwise, the process 1800 proceeds to S1840.

At 51840, the controller can determine whether the beamwidth adjustment is needed, for example, based on steering angle and beambook, in order to make the beam footprint size is less than the threshold (and not less than another threshold). If so, the process 1800 proceeds to S1850. Otherwise, the process 1800 proceeds to S1860. At S1850, the controller adjusts the beamwidth, e.g., based on the steering angle and beambook. At S1860, the controller can determine the Tx power of each antenna element to transmit the signal (or the beam). The process 1800 then returns to 51810.

4. Beam Footprint Adaptation Based on Base Station Policy and UE Assistance Information

In some examples, beam footprint adaptation by adjusting the beamwidth can be based on base station (e.g., gNB) policy, and, additionally, may consider the UE assistance information. Examples of methods based on consideration of policy and UE assistance information are described below. It is noted that the beam footprint adaptation can be applied to control beams as well as data beams.

Method 1: Based on the number of UEs in the affected area.

An affected area can be defined as the area affected by adjusting the beamwidth. For example, the affected area can be located near an edge of a footprint. Thus, when the footprint changes its size, the coverage status of the affected area will be changed between being covered and not being covered. For example, for a specific UE, when the distance (D_UE) between the UE and a cell reference point is less than a threshold, Thres_3, and larger than another threshold, Thres_4, i.e., Thres_4<D_UE<Thres_3, the UE can be said to be within the affected area.

For example, if there is at least one connected UE in the affected area, the gNB may decide not to adjust the beamwidth. For example, if the number of connected mode UE (served UE) in the affected area is greater than a threshold, the gNB may decide not to adjust the beamwidth. In this way, the UEs will not lose the coverage. For example, if there is no connected UE in the affected area, the gNB may decide to adjust the beamwidth. The number of UEs in the affected area may be known from the UE-reported TAs or UE locations.

Method 2: Based on the interference to other beams.

The controller of the neighboring beam/cell can notify the gNB about the interference level. For instance, if the interference level for the neighboring beam exceeds a certain threshold, as reported by other controllers, the gNB may adjust the beamwidth to reduce the beam footprint size. Similarly, if the interference for other beams surpasses a threshold, the controllers of those beams may inform the gNB to decrease the beam footprint size.

Method 3: Based on the signaling quality of UE(s) within the beam.

UEs report the received Channel State Information (CSI) to the gNB. If the CSI of a UE falls below a threshold while being in an affected area, the gNB may initiate a handover to another beam/cell and subsequently reduce (or shrink) the beam footprint size by decreasing the beamwidth. If the CSI of a UE falls below a threshold, but the UE is not within an affected area, the gNB may reduce the beam footprint size to improve signaling strength for the UE. If there are no connected mode UEs being served in the beam, the gNB may employ a wider beamwidth to create a larger beam footprint covering a larger area of the Earth's surface. Conversely, if there are connected UEs in the beam, the gNB may reduce the beamwidth to form a smaller beam footprint, specifically serving the UEs in question.

Method 4: Based on the UE preference.

In some cases, the gNB may not adjust the beamwidth based on the UE reported preference if the UE is in the affected area and the UE prefers using the current beam. The UE preference include: an indicator which indicates whether UE wants to stay within the current beam or not; at least a beam/cell ID which UE prefers to utilize; measurement results (of measuring a first reference signal from a serving beam and measuring a second reference signal from a neighbor beam); and the required service time.

Method 5: Based on a network scheduling.

The gNB may perform beamwidth adjustment based on how many beams/cells (including neighbor satellite) available for serving a UE in the current beam coverage. For example, the UE may report the measurement results of the neighbor beams and the UE is in the affected area. If there are other beams/cells covering the UE available, the gNB may decide to handover this UE to another beam/cell and shrink the beam footprint (reduce the beamwidth). If there is only one beam covering the UE (e.g., no other beam available (no radio resource management (RRM) results)), the gNB may not shrink the beam footprint.

The gNB may perform beamwidth adjustment based on beam hopping policy. For example, the network may use one beam to serve multiple areas periodically (TDM method).

Method 6: Based on gNB/network preference.

The gNB/network may prefer to serve some UEs first, e.g., based on user service subscription, data priority, service type. The UEs with high priority are served first.

In some examples, the base station policy-based beam adaptation methods may be combined with other beam adaptation considerations. For example, the policy-based beam adaptation methods may be employed and performed before S1840, between S1840 and S1850, or in parallel with S1840.

5. Additional Examples of Beam Adaptation

(A) Beam Adaptation (Control/data beam)

A method of a controller managing a beam can include determining a beam configuration based on an area and a satellite ephemeris when a predefined condition is met; setting each antenna element based on the beam configuration; and transmitting a signal based on the beam configuration. The predefined condition can include a policy; a periodic timer expiry; a satellite position in a predefined position; a steering angle of the beam reaching a predefined angle; an assistant information reported by a UE in the service area meeting a criteria; when a data transmission to a scheduled UE in the scheduled area is needed; or when a control signal to a service area is needed.

The policy can include at least one of factors: the number of scheduled UEs in an affected area, an interference to other beams, a signaling quality of a UE within the beam coverage, a UE preference, a network preference, and a number of beams/cells (including neighbor satellite) to serve a UE in a beam coverage, a beam hopping policy. The area can further comprise a service area wherein the service area is served by a control beam; or a scheduled area wherein the scheduled area is served by a data beam.

The determining the beam configuration can be based on a beambook. The beambook can be obtained from a server which maintains a set of beambooks; or generated by the controller based on the service area and the satellite ephemeris. The beambook can include a steering angle or a satellite position; and an on/off (active/inactive) indication, an amplitude and a phase for each antenna element, or an amplitude and a delay for each antenna element.

The beam configuration can include a steering angle or a satellite position for the beam to serve the service area; and an on/off (active/inactive) indication for each antenna element. The beam configuration can include a steering angle or a satellite position for the beam to serve the service area; and an amplitude and a phase, or an amplitude and a delay for each antenna element, wherein when the amplitude equals to zero, it means that the corresponding antenna element is inactive/off. The steering angle can be represented by an elevation angle and an azimuth angle. A transmitting power for each active/on antenna element is determined based on a total transmitting power. The beam configuration can include a transmitting power for each antenna element.

In some examples, the number of UEs in the affected area can be determined by a UE reported TA or the UE location. The interference to other beams is determined by receiving an interference level from a second controller of a neighbor beam/cell. The signaling quality of the UE(s) within the beam is obtained by receiving an CSI report from the UE. The UE preference can include an indicator to indicate whether the UE prefers to stay the current beam and/or the required service period. The network preference can include a user service subscription, a user data priority, or a service type of UE data. The number of beams/cells (including neighbor satellites) to serve a UE in the current beam coverage is determined by receiving a measurement result of a neighbor beam from the UE.

(B) Beam Adaptation (UE Behavior for Control and Data Beam) (1)

A method for a UE to assist beam management can include measuring a first reference signal from a first beam; calculating a first elevation angle for a first satellite; and reporting an assistant information including a first measured result of the first reference signal and the first elevation angle. The assistant information can include a UE location or a TA value. The method can further include measuring a second reference signal from a second beam; and the assistant information further including a second measured result of the second reference signal. The assistant information can further include a UE preference wherein the UE preference includes a list of beam/cell ID which UE prefers to utilize, or a required service time.

(C) Beam Adaptation (UE Behavior for Control and Data Beam) (2)

A method for a UE to assist beam management can include reporting a UE preference. The UE preference can include an indicator which indicates whether UE wants to stay the current beam or not. The UE preference can include at least a beam/cell ID which UE prefers to utilize. The method can include measuring a first reference signal from a serving beam; and measuring a second reference signal from a neighbor beam. The method can include reporting a measurement result for the serving beam and the neighbor beam. The UE preference can include a required service time.

V. Beam Switching

1. Beam Switching Process

While a satellite moving on the orbit, the satellite can transmit a beam and maintain a constant beam footprint to cover a target service area. As the satellite moves away from the target service area, a steering angle of the beam may reach a maximum steering angle threshold. A controller may perform a beam switching at this moment. The following operations may be carried out at the satellite side or the UE side.

In some examples, for control beams, prior to reaching the predefined angle (e.g., the maximum steering angle for service), the controller initiates handover of connected mode UEs to neighboring beams/cells, including the possibility of handover to the next satellite if applicable. Once the steering angle reaches the predefined maximum angle, the controller ceases transmission of signaling to the service area. For data beams, once the steering angle reaches the predefined maximum angle, the controller discontinues transmission of signaling to the scheduled area (for example, covered by a data beam).

For connected mode UEs, prior to reaching the predefined maximum angle, the UE can perform handover based on handover commands or engage in conditional handover (CHO) based on CHO configurations. In case of handover or CHO failure, the UE may declare a radio link failure (RLF) and proceed with radio resource control (RRC) reestablishment. For idle mode UEs, the serving beam can be deprioritized or excluded for cell reselection. Prior to the steering angle reaching the predefined maximum angle, the UE can perform cell reselection to camp on a neighboring cell. If unable to camp on a cell, the UE may engage in a cell selection (cell search).

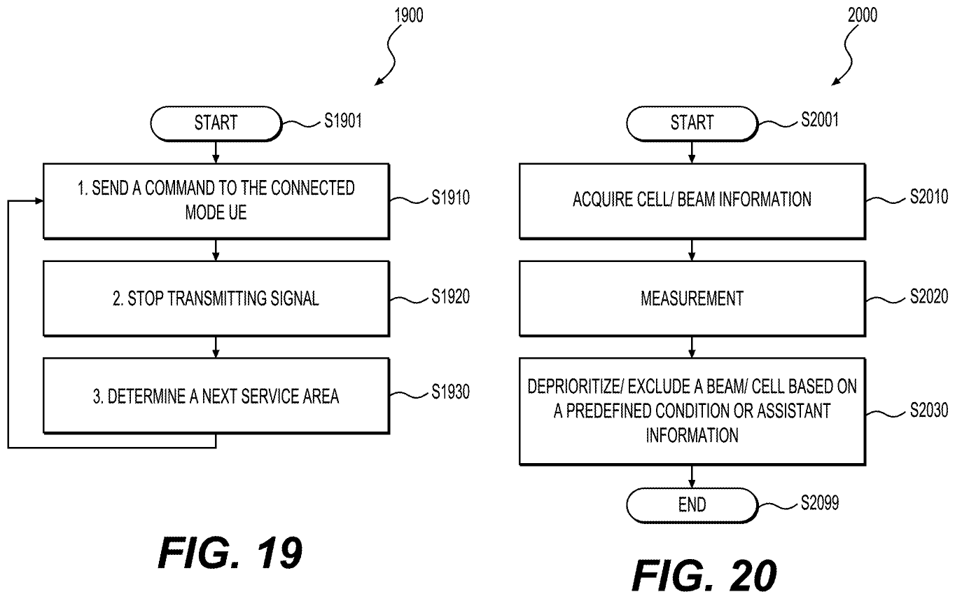

FIG. 19 shows a control beam switching process 1900 according to embodiments of the disclosure. The process 1900 can start from S1901 and proceed to S1910. At 51910, the controller can issue a command to connected mode UEs within a service area covered by the serving beam before the steering angle of the serving beam reaches a predefined angle. The command can be a CHO command, a handover command, or an RRC release message. The command may be sent through unicast, multicast, or broadcast methods.

At 51920, the controller controls the satellite to cease signal transmission to the service area when the steering angle of the serving beam reaches the predefined angle. At S1930, the controller can determine a next service area and initiate beam preparation or initiation accordingly. The process 1900 can return to S1910 for handling another beam switching when the satellite moves away from the next service area.

The release message can include a cause (e.g., cause: out-of-coverage) and optional additional assistance information. For example, the UE assistance information can include a stop time of service by the current beam, an inactive timer for the UE to enter sleep mode (or sleep state), and a set of satellite ephemeris information.

2. Further Examples of Beam Switching

A method of a controller managing a connected mode UE can include sending a command to the connected mode UE in a service area which is covered by a serving beam before a steering angle of the serving beam reaches a predefined angle; and stopping transmitting signal to the service area when the steering angle of the serving beam reaches the predefined angle. The command can include a pre-configuration for the UE to perform a CHO; a handover command; or a release message to release UE to idle/inactive mode. The command can be sent by unicast, multicast or broadcast. The release message can include a cause to indicate out of coverage. The release message can include assistant information which includes a stop time of service; an inactive timer for the UE to go to a sleep state; or a set of satellite ephemeris information. The method can further include determining a next service area.

A method of a controller managing a beam can include stopping transmission to a scheduled area when a steering angle of the beam reaches a predefined angle.

A method of a connected-mode UE leaving a serving beam before the beam stops serving a service area can include performing handover based on a handover command or performing CHO based on a CHO configuration before a steering angle of the serving beam reaches a predefined angle; and performing radio link failure (RLF) handling and RRC reestablishment, if HO/CHO fails.

A method of an idle-mode UE leaving a serving beam before the serving beam stops serving a service area can include deprioritizing or excluding the serving beam for cell reselection; performing cell reselection to camp on a neighbor cell, before a steering angle of the serving beam reaches a predefined angle; and performing cell selection or cell search if failure to camp on the neighbor cell.

VI. Beam Selection

Because of beam footprint variation overtime, for an idle/inactive mode UE, the UE may frequently camp on different beam/cell over the time when the UE is outside the service area that correspond to a cell and targeted by a beam. This may cause UE more power consumption. The present disclosure provides methods to avoid a UE outside the service area camping on the beam/cell.

For example, a satellite may transmit a beam to cover a target service area corresponding to an earth-fixed cell of an NTN system. Due to the motion of the satellite and/or the beam steering angle applied, the beam footprint may vary in terms of, for example, beam size, beam shape, beam location, and the like. The beam footprint variation may cause UEs near the border of the earth-fixed cell (either inside the cell or outside the cell) to change between being covered by the beam or not being covered by the beam. This may cause the UEs to switch the cells the UEs camp on. For example, when a UE is within the coverage of the current beam (the strength of the beam signal being above a threshold), the UE can decide to camp on the cell corresponding to the beam. When the UE is out of the coverage of the current beam, the UE may perform a cell (re)selection process to detect a neighboring cell (for example, receiving synchronization signals of the neighboring cell) to camp on. Later, due to variation of the footprint of the current beam, the UE may be covered by the current beam again, and thus switch from the neighboring cell to the current cell to camp on again. This kind of frequently switching between different cells may increase the UE's power consumption.

Cell search can be the procedure by which a UE acquires time and frequency synchronization with a cell and detects the Cell ID of that cell. For example, NR-based satellite cell search can be based on the primary and secondary synchronization signals, and physical broadcast channel (PBCH) demodulation reference signal (DMRS). For example, a UE can determine a cell ID by decoding a synchronization signal block (SSB).

When earth-fixed cell configuration is employed for an NTN system, a cell can correspond to a specific service area. A satellite while moving can employ a steerable beam to cover the service area. Thus, the cell can correspond to such a steerable beam. In this context, cell (re)selection can be viewed as a beam (re)selection. A cell can refer to a geographical area. A cell can also be a logical entity associated with a cell identifier (ID), and a UE can perform cell selection or reselection to camp on such a cell.

1. UE Cell Selection and Reselection Methods

Various methods for a UE to select or reselect a cell (or beam) in an NTN system are described below. In the various methods, the UE can perform cell (or beam) selection or reselection based on various considerations. The factors considered are indicated in the titles of the methods below. For example, based on the considerations, a UE may deprioritize or exclude a cell (or beam) from a candidate cell (or beam) list.

Method 1: Distance between UE location and reference point.

If the distance between UE location and the reference point of the beam/cell exceeds a threshold, the UE may deprioritize or exclude the beam/cell. The reference point location and threshold may be broadcasted by the serving cell or the cell. UE avoids measuring the beam/cell when the distance exceeds the threshold. The reference point can be the center of the service area or the cell.

Method 2: Signaling strength variation below a threshold.

UE measures a beam for a specific period, and if the signal strength variation is below a threshold, the beam is considered a candidate beam/cell. If the signal strength variation exceeds the threshold, the UE may deprioritize or exclude the beam/cell in the candidate list.

Method 3: Elevation angle.

UE obtains the elevation angle for the beam based on satellite ephemeris information broadcasted in the beam/cell or serving cell and the UE location. Or, the UE estimates the elevation angle by tuning the phase of each receiving antenna element to obtain the largest RSRP. If the elevation angle is below a threshold, the UE may deprioritize or exclude the beam/cell.

Method 4: UE preference.

The UE may select a beam/cell with a higher priority based on UE preference.

For example, the UE prioritizes beam/cell selection based on user preference, giving higher priority to preferred options.

Even if the UE is outside the service area of a beam/cell, the UE may prefer to camp on the beam/cell and may assign a high priority to the beam/cell. For example, if a beam/cell provides the services, slices, or the like, the UE prefers, the UE may prioritize the beam/cell. For example, if the UE detects that the available time of a beam/cell is sufficient to complete a transmission, the UE may select the beam/cell.

A cell/beam not included in the UE's preference list may be deprioritized or excluded. If the service provided by a cell is not in the UE's preference list, the cell/beam may be deprioritized or excluded. For instance, if a slice broadcasted by the cell is not in the UE's preferred list. the cell/beam may be deprioritized or excluded. If the available/service time of a cell is less than what the UE requires, the cell/beam may be deprioritized or excluded.

Method 5: UE stored information.

UE can store and maintain a preferred cell list. If a beam/cell is not in the list, the UE may not select the beam/cell or may deprioritize the beam/cell. The list may be linked with a time. Thus, the UE may have different cell lists in use for different time. The RRC release message may contain a cell list which the UE can deprioritize the cells in the cell list.

The UE can store visited cell information, including available time, cell reference point, and cell radius associated with visited cells on a list of visited cells. The UE may deprioritize or exclude a cell/beam if the distance from UE to cell reference point exceeds a threshold or cell radius. For a cell having an available time less than the UE required, the UE may deprioritize or exclude a cell/beam in the candidate cell list. Or, the UE may include the cell in a barred cell list. If a cell is listed in a barred cell list, the UE may deprioritize or exclude the cell/beam.

The UE can store ephemeris information of a satellite providing a service to a cell. Based on ephemeris information, the UE calculates elevation angle, available or potential service time, distance from the satellite to the UE, and the like. The UE may deprioritize or exclude the cell/beam if the elevation angle of the satellite is below a threshold, the potential service time is insufficient, or the distance exceeds a threshold.

Method 6: Ranking

For purpose of (re)selection of a cell/beam, a UE may rank cell/beams based on a distance between the UE location and respective reference point in the beam footprint of the respective cell, a satellite elevation angle corresponding to the respective cell, and a number of detectable beams of the respective cell. In some examples, the UE assigns a score to each beam/cell based on distance from reference points, elevation angles, and number of detectable beams. The UE may deprioritize or exclude a cell/beam if the ranking or score falls below a threshold.

2. Cell/Beam Selection and Reselection Process

FIG. 20 shows a cell/beam selection and reselection process 2000 according to embodiments of the disclosure. The process 2000 can start from S2001 and proceed to S2010.

At S2010, a UE can acquire cell/beam information to be used for cell (re)selection. For example, the UE can be within a coverage of an NTN and operate in an idle mode. For example, when the UE is powered on, the UE can perform a cell/beam selection process to search for a cell (e.g., an earth-fixed cell covered by a satellite) to camp on. When the UE moves out of the coverage of the cell, or the UE is going to lose the coverage of the current cell/beam due to motion of the satellite, the UE may perform a cell/beam reselection process. During the cell (re)selection process, the UE may scan different frequency bands or carriers to detect one or more candidate cells. The UE may maintain or employ one or more candidate cell lists to facilitate the (re)selection operation. For example, one or more candidate cell lists may provide information of priorities of those candidate cells, information of barred or forbidden cells, and the like. Also, during the (re)selection, the UE may consider some preconfigured conditions and/or other additional information (e.g., assistance information).

At S2010, the cell/beam information obtained may include, for each of multiple candidate cells, a reference location of the respective cell/beam (e.g., a reference location within the earth-fixed cell, the beam footprint, or service area corresponding to the respective cell/beam), ephemeris information of the respective satellite (e.g., cells/beams may be formed by different satellites), one or more measurement targets (measurement quantities) (such as reference signal received power (RSRP), received signal received quality (RSRQ), and the like), one or more types of thresholds (e.g., a distance threshold of the distance between the UE and the reference location, and an elevation threshold), and the like.

Some of the cell/beam information can be obtained from various sources, such as system information of a serving cell, information stored in the UE, system information of a neighboring cell, an RRC release message, information received from the base station (or satellite), and the like. Some of the cell/beam information may be obtained at the UE, such as the location of the UE. Some of the cell/beam information may be derived from the information obtained. For example, the UE may determine a satellite elevation angle of the respective cell/beam based on the UE location and the ephemeris information. The UE may determine a distance between the UE and the reference location. Some of the cell/beam information may be measurement results from a measurement process. The information determined by the UE can be referred to as cell-selection information.

At S2020, the UE may perform a measurement to obtain information to be used for cell/beam (re)selection. For example, the UE may obtain the following measurement results: distance between the UE and the reference location of a candidate cell; a satellite elevation angle of the candidate cell; RSRP or RSRQ measurements; and the like.

At S2030, the UE may carry out a cell/beam (re)selection process based on the information obtained at S2010 and S2020. For example, during the cell/beam (re)selection process, the UE can deprioritize or exclude a cell/beam based on one or more predefined conditions or some assistance information. For example, the predefined conditions can include: if a distance between the UE location and a reference location is greater than a threshold; if an elevation angle of a satellite viewed from the UE is less than a threshold; or if a measured RSRP/RSRQ varying exceeds a threshold; or other conditions. The assistance information can include, for example, a UE preference, UE stored information, ranking of candidate cells, and the like. The process 2000 can proceed to S2099 and terminate at S2099.

3. Further Examples of Beam/Cell Selection and Reselection: Avoid Camping on a Temperate Beam/Cell

A method of a UE performing cell selection/reselection can include acquiring cell/beam information; deprioritizing or excluding the cell/beam when performing cell selection/reselection based on if a predefined condition is met according to the cell/beam information or based on an assistance information. The predefined condition include: if a distance between the UE location and a reference location is greater than a threshold; if an elevation angle of a satellite viewed from the UE is less than a threshold; or if a measured RSRP/RSRQ varying exceeds a threshold. The cell/beam information is acquired from a system information of a serving cell; a stored information; a system information of a neighboring cell; or an RRC release message.

The cell/beam information can include one of a reference location for the cell/beam; an ephemeris information of a satellite; a measurement target, i.e., RSRP or RSRQ or both; and various thresholds. The elevation angle can be determined by tuning a phase of each receiving antenna element to obtain the largest RSRP; and estimating the elevation angle based on the phase of each receiving antenna element. The elevation angle can be determined by an ephemeris information of the satellite and a UE location.

The assistance information can include a UE preference, a UE stored information, or a ranking or a score of a cell. The UE preference can be determined based on a service provided by the cell/beam not in the UE preference list; or an available/service time of the cell less than that UE required. The UE stored information can include visited cell information including at least one of time, a cell reference point, a cell radius; a preferred cell list; a barred cell list; or an ephemeris information of a satellite.

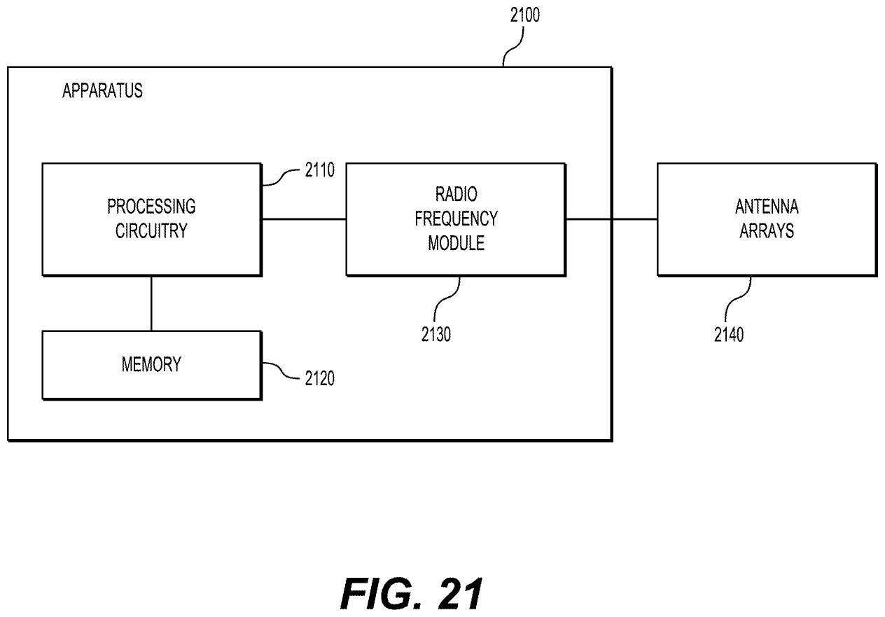

FIG. 21 shows an apparatus 2100 according to embodiments of the disclosure. The apparatus 2100 can be configured to perform various functions in accordance with one or more embodiments or examples described herein. Thus, the apparatus 2100 can provide means for implementation of mechanisms, techniques, processes, functions, components, systems described herein. For example, the apparatus 2100 can be used to implement functions of UEs, satellites, controllers onboard satellites, or base stations, in various embodiments and examples described herein. The apparatus 2100 can include a general-purpose processor or specially designed circuits to implement various functions, components, or processes described herein in various embodiments. The apparatus 2100 can include processing circuitry 2110, a memory 2120, and a radio frequency (RF) module 2130.

In various examples, the processing circuitry 2110 can include circuitry configured to perform the functions and processes described herein in combination with software or without software. In various examples, the processing circuitry 2110 can be a digital signal processor (DSP), an application-specific integrated circuit (ASIC), programmable logic devices (PLDs), field programmable gate arrays (FPGAs), digitally enhanced circuits, or comparable device or a combination thereof.

In some other examples, the processing circuitry 2110 can be a central processing unit (CPU) configured to execute program instructions to perform various functions and processes described herein. Accordingly, the memory 2120 can be configured to store program instructions. The processing circuitry 2110, when executing the program instructions, can perform the functions and processes. The memory 2120 can further store other programs or data, such as operating systems, application programs, and the like. The memory 2120 can include non-transitory storage media, such as a read-only memory (ROM), a random-access memory (RAM), a flash memory, a solid-state memory, a hard disk drive, an optical disk drive, and the like.

In an embodiment, the RF module 2130 receives a processed data signal from the processing circuitry 2110 and converts the data signal to beamforming wireless signals that are then transmitted via antenna arrays 2140, or vice versa. The RF module 2130 can include a digital-to-analog converter (DAC), an analog-to-digital converter (ADC), a frequency-up-converter, a frequency-down-converter, filters and amplifiers for reception and transmission operations. The RF module 2130 can include multi-antenna circuitry for beamforming operations. For example, the multi-antenna circuitry can include an uplink spatial filter circuit, and a downlink spatial filter circuit for shifting analog signal phases or scaling analog signal amplitudes. The antenna arrays 2140 can include one or more antenna arrays.

The apparatus 2100 can optionally include other components, such as input and output devices, additional or signal processing circuitry, and the like. Accordingly, the apparatus 2100 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through a physical medium or distributed system, including, for example, from a server connected to the Internet.

The computer program may be accessible from a computer-readable medium providing program instructions for use by or in connection with a computer or any instruction execution system. The computer-readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid-state memory, magnetic tape, a removable computer diskette, a random-access memory (RAM), a read-only memory (ROM), a magnetic disk and an optical disk, and the like. The computer-readable non-transitory storage medium can include all types of computer-readable medium, including magnetic storage medium, optical storage medium, flash medium, and solid-state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method, comprising:
receiving, by a user equipment (UE), cell information of cells that are each associated with a cell identifier and formed by a beam transmitted from a respective satellite;
determining, by the UE, cell-selection related information based on part of the received cell information; and
performing, by the UE, cell selection or reselection based on the cell information and the cell-selection related information, wherein a subset of the cells are deprioritized or excluded for the cell selection or reselection.

2. The method of claim 1, wherein the cell information is received from one of:
a system information of serving cell,
information stored in the UE,
system information of a neighboring cell, and
a radio resource control (RRC) release message.

3. The method of claim 1, wherein the cell information includes one of:
a reference location of one of the cells,
an ephemeris of one of the respective satellites,
one or more measurement quantities,
a threshold of a distance between a location of the UE and a reference location of one of the cells, and
a threshold of an elevation angle of one of the respective satellites with respect to the UE.

4. The method of claim 3, wherein the determining cell-selection information includes:
determining a distance between the UE and the reference location of one of the cells.

5. The method of claim 3, wherein the determining cell-selection information includes:
determining an elevation angle of the one of the respective satellites with respect to the UE based on a UE location and the ephemeris of the one of the respective satellites.

6. The method of claim 3, wherein the determining cell-selection information includes:
determining an elevation angle of the one of the respective satellites based on a phase of each antenna element of an antenna array that corresponds to a largest reference signal received power (RSRP) measured at the UE.

7. The method of claim 1, wherein the performing includes:
in response to a distance between a location of the UE and a reference point of one of the cells being greater than a threshold, determining to exclude or deprioritize the one of the cells for the cell selection or reselection.

8. The method of claim 1, wherein the performing includes:
in response to a variation of signal strength of one of the cells being above a threshold, determining to exclude or deprioritize the one of the cells for the cell selection or reselection.

9. The method of claim 1, wherein the performing includes:
in response to an elevation angle of one of the respective satellites with respect to the UE is less than a threshold, determining to exclude or deprioritize one of the cells corresponding to the one of the respective satellites for the cell selection or reselection.

10. The method of claim 1, wherein the performing includes:
performing the cell selection or reselection based on priorities associated with ones of the cells that are each associated with the cell identifier and formed by the beam transmitted from the respective satellite.

11. The method of claim 1, wherein the performing includes:
in response to one of the cells providing a service or a slice the UE prefers, prioritizing the one of the cells for the cell selection or reselection.

12. The method of claim 1, wherein the performing includes:
in response to detecting an available time of one of the cells being enough for the UE to complete a transmission, prioritizing the one of the cells for the cell selection or reselection.

13. The method of claim 1, wherein the performing includes:
performing the cell selection or reselection based on a list of visited cells each associated with visited-cell information that includes one of:
available time indicating when the respective cell is available,
a reference point of the respective cell, and
a size of the respective cell.

14. The method of claim 1, wherein the performing includes:
performing the cell selection or reselection based on a ranking of the cells, wherein the cells are ranked based on reference points of the cells, satellite elevation angles of the cells, and detectable beams of the cells.

15. An apparatus comprising circuitry configured to:
receive cell information of cells that are each associated with a cell identifier and formed by a beam transmitted from a respective satellite;
determine cell-selection related information based on part of the received cell information; and
perform cell selection or reselection based on the cell information and the cell-selection related information, wherein a subset of the cells are deprioritized or excluded for the cell selection or reselection.

16. The apparatus of claim 15, wherein the cell information is received from one of:
a system information of serving cell,
information stored in the UE,
system information of a neighboring cell, and
a radio resource control (RRC) release message.

17. The apparatus of claim 15, wherein the cell information includes one of:
a reference location of one of the cells,
an ephemeris of one of the respective satellites,
one or more measurement quantities,
a threshold of a distance between a location of the UE and a reference location of one of the cells, and
a threshold of an elevation angle of one of the respective satellites with respect to the UE.

18. The apparatus of claim 17, wherein the circuitry is further configured to:
determine a distance between the UE and the reference location of one of the cells.

19. The apparatus of claim 17, wherein the apparatus is further configured to:
determine an elevation angle of the one of the respective satellites with respect to the UE based on a UE location and the ephemeris of the one of the respective satellites.

20. A non-transitory computer-readable medium storing instructions that, when executed by a processor, cause the processor to perform a method, the method comprising:
receiving at a user equipment (UE) cell information of cells that are each associated with a cell identifier and formed by a beam transmitted from a respective satellite;
determining cell-selection related information based on part of the received cell information; and
performing cell selection or reselection based on the cell information and the cell-selection related information, wherein a subset of the cells are deprioritized or excluded for the cell selection or reselection.
